(19) United States
(12) Patent Application Publication
(10) Pub. No.: US 2020/0354273 A1
(43) Pub. Date: Nov. 12, 2020

(54) COARSE AGGREGATE FOR CONCRETE

(71) Applicant: IBH SHIBATA, INC., Kawasaki-shi (JP)

(72) Inventors: Junichi SHIBATA, Kawasaki-shi (JP); Manzo UCHIGASAKI, Kawasaki-shi (JP)

(73) Assignee: IBH SHIBATA, INC., Kawasaki-shi (JP)

(21) Appl. No.: 16/833,998

(22) Filed: Mar. 30, 2020

(30) Foreign Application Priority Data
Mar. 29, 2019 (JP) 2019-069447
Apr. 11, 2019 (JP) 2019-075574
Jul. 10, 2019 (JP) 2019-128598
Jul. 10, 2019 (JP) 2019-128625
Sep. 20, 2019 (JP) 2019-172347
Dec. 25, 2019 (JP) 2019-234290
Jan. 7, 2020 (JP) 2020-000931
Jan. 7, 2020 (JP) 2020-000999

(51) Int. Cl. C04B 20/00; C04B 14/34; C04B 18/02

(52) U.S. Cl. CPC C04B 20/0068; C04B 14/34; C04B 2111/40; C04B 18/027; C04B 20/0008

(57) ABSTRACT

Provided is a novel metallic coarse aggregate for concrete which can be used as a coarse aggregate which is one of the essential constituents of concrete, can further improve the compressive strength and tensile strength of concrete, is less likely to be sedimented in fresh concrete, and has good productivity at a low cost. The metallic coarse aggregate for concrete includes a coarse aggregate body including a spherical cap portion bonded body having two hollow spherical cap portions and an annular portion protruding from a surface of the spherical cap portion bonded body so as to surround an outer periphery of the spherical cap portion bonded body, the annular portion having a shape in which a corner of a rectangular shape is bent upward or downward.

### TECHNICAL FIELD

The present invention relates to a coarse aggregate for concrete.

### BACKGROUND ART

Concrete is a substance normally obtained by solidifying so-called fresh concrete, which is obtained by mixing water, a coarse aggregate (crushed stone or gravel), and a fine aggregate (sand) in cement, on the basis of a hydration reaction of the water and the cement. Such concrete is widely used as a constructional material.

Concrete has a disadvantage of exhibiting very low tensile strength and bending strength compared to compressive strength. In order to compensate the concrete for such a disadvantage, it is generally performed that reinforcing bars assembled in a matrix (or lengthwise and breadthwise) form are disposed in concrete. There have been known a technique in which propylene fibers are contained as a reinforcing fiber in fresh concrete (Patent Literature 1), a technique in which organic fibers, amorphous steel fibers, or the like are contained in fresh concrete (Patent Literature 2), and a technique in which a reinforcing material such as an iron piece, a steel piece, high tensile strength carbon fibers, or glass fibers are protruded from an artificial aggregate forming material formed from expanded shale or the like (Patent Literature 3). Further, for the purpose of improving compressive strength and tensile strength by the shape of a coarse aggregate itself, there have been proposed, for example, a coarse aggregate in which spheres with a flange, each obtained by disposing two hemispherical molding products formed by pressing out a metal plate so as to face each other and bonding them to each other, are connected to each other by a connection portion having a narrow width (Patent Literatures 4 and 5) and a coarse aggregate having a shape in which both ends of a metal pipe are closed in a mutually different direction (Patent Literature 6). Further, for the purpose of improving adhesion between a metallic coarse aggregate and mortar, there have been proposed a coarse aggregate in which a thin wire of gauge No. 20 or more penetrates a metallic coarse aggregate body such that the wire is easily wound around the coarse aggregate body (Patent Literature 7). According to this coarse aggregate, the wire is wound around the coarse aggregate body during stirring of the fresh concrete, and the mortar is further captured by the wound wire, causing the coarse aggregate and the mortar to move integrally. This can provide an advantage in that the coarse aggregate is less likely to be sedimented in the fresh concrete, leading to excellent dispersibility of the coarse aggregate.

### CITATION LIST

### Patent Literature

Patent Literature 1: Japanese Patent Application Laid-Open No. 2017-178755

Patent Literature 2: Japanese Patent Application Laid-Open No. 2001-220201

Patent Literature 3: Japanese Patent Application Laid-Open No. Sho. 63-206337

Patent Literature 4: Japanese Utility Model Registration Publication No. Sho. 45-7674

Patent Literature 5: Japanese Utility Model Registration Publication No. Sho. 45-7675

Patent Literature 6: Japanese Patent No. 6485932

Patent Literature 7: Japanese Patent No. 6532073

### SUMMARY OF INVENTION

### Technical Problem

In a case where the reinforcing fiber is mixed in the fresh concrete as described in Patent Literatures 1 and 2, the reinforcing fiber is sometimes aggregated instead of being uniformly dispersed in the whole fresh concrete. In such a case, various strengths may vary from place to place in a concrete construction, causing a problem in which stress is concentrated on a location where the strength is relatively low, likely resulting in the occurrence of cracking in the concrete. Further, the reinforcing fiber is not an essential constituent component of the concrete conventionally used. Thus, there is a concern that using the reinforcing fiber makes it difficult to perform blending and adjustment of the constituent component of the concrete for obtaining predetermined concrete properties.

On the other hand, according to the coarse aggregates described in Patent Literatures 3 to 6, they can be used instead of the conventional coarse aggregate formed from crushed stones or gravel, and thus, the blending of the constituent component of the concrete can be easily adjusted. Further, the metallic coarse aggregates described in Patent Literatures 4 to 6 make it possible to increase tensile strength as compared with the conventional coarse aggregate. However, the coarse aggregates described in Patent Literatures 4 to 6 are easily sedimented in the fresh concrete, causing a problem of making it difficult to obtain the concrete in which the coarse aggregates are uniformly dispersed. In addition, it is also desired to further improve compressive strength and tensile strength.

Further, as described in Patent Literature 7, winding the wire around the metallic coarse aggregate body can improve the adhesion between the coarse aggregate and the mortar. However, inconsistency of the winding of the wire around the coarse aggregate body may cause variation in the tensile strength.

In order to cope with these problems of the conventional techniques of Patent Literatures 1 to 6, it is an object of the present invention to provide a novel material, which can be used as a coarse aggregate serving as an essential constituent component of concrete, which can further improve compressive strength and tensile strength of concrete, which is less likely to be sedimented in fresh concrete, and which can be obtained with high productivity and at a low cost. Further, besides the aforementioned problems, in order to cope with the problem of the conventional technique of Patent Literature 7, it is another object of the present invention to significantly improve tensile strength of concrete by more reliably improving adhesion between mortar and a coarse aggregate and thereby preventing breakage of a mortar part.

### Solution to Problem

The present inventor has found that a coarse aggregate body having a shape of sphere or a shape similar to sphere (hereinafter, sometimes referred to as a spherical shape) has high strength to compression and tension in any direction due to its shape, and thus concrete prepared by using this coarse aggregate body can improve compressive strength and tensile strength, and that the coarse aggregate body having a shape of sphere or a shape similar to sphere can be easily produced by bonding two spherical cap portions, or the like.

Further, the present inventor has found that, in the production of the spherical coarse aggregate, an annular portion is protruded so as to surround the outer periphery of the spherical shape, the annular portion is rectangularly shaped, and, further, corners of the annular portion are bent, so that the spherical shape having the rectangular annular portion, not only exhibits the aforementioned advantageous effect, but also can be extremely easily produced by press processing using a metal plate or a metal pipe without generating punched debris.

Further, the present inventor has found that, when the coarse aggregate includes a plurality of the spherical portions having a shape of sphere or a shape similar to sphere, and the coarse aggregate has a sufficient width equal to or greater than the minimum diameter of the spherical portions in a connection portion where the plurality of spherical portions are directly connected to each other, the coarse aggregate has high strength to compression and tension in any direction due to its shape and thus exhibits the above advantageous effect. Furthermore, the present inventor has found that the shape of the coarse aggregate in which the connection portion of the spherical portions has the width equal to or greater than the minimum diameter of the spherical portions makes it possible to omit a punching step for forming the connection portion, which can increase productivity of the coarse aggregate, that the annular portion protruded from the surface of the spherical portions so as to surround the outer periphery of the plurality of spherical portions improves adhesion between the coarse aggregate and mortar, which can also improve strength of the concrete as well as dispersibility in the fresh concrete, and that the annular portion reduces the tendency of rolling of the coarse aggregate, which can improve handleability of the coarse aggregate.

Furthermore, the present inventor has found that, when the coarse aggregate body having a shape of sphere or a shape similar to sphere is made hollow, a plurality of flexible wires penetrates the hollow coarse aggregate body, and, for example, the plurality of wires protrudes from the coarse aggregate body or an outer fitting portion in which the wires are bent into an annular shape is externally fitted to the hollow coarse aggregate body, the coarse aggregate is less likely to be sedimented in the fresh concrete, which can improve dispersibility in the concrete. The present inventor has found that, in particular, when a plurality of the wires which have small diameters and are easily bent are used and the protrusion lengths of the wires have a sufficient length for the coarse aggregate body to be wound and entangled with the wires, the coarse aggregate body is wound and entangled with the wires by stirring of the fresh concrete or the like, thereby being covered with the wires, and the mortar is then captured by the wires, causing the actual specific gravity of the coarse aggregate to approach that of the mortar, and as a result, the coarse aggregate is further less likely to be sedimented in the fresh concrete and dispersibility in the concrete is improved. The present inventor has also found that, although, according to the descriptions in Patent Literatures 4 and 5, the punching step is required for the forming process of the shape in which the metal plate is molded into a spherical shape and then the spherical coarse aggregates are connected to each other by the connection portion having a narrow width, such a punching step is not required for the coarse aggregate including the coarse aggregate body and the wires, making it possible to reduce a production cost of the coarse aggregate accordingly.

Further, the present inventor has found that, when a specific metallic mesh material molded so as to be hollow is used as a coarse aggregate for concrete, the mortar intrudes inside the coarse aggregate through a hole of the metallic mesh material forming the outer surface of the coarse aggregate, and the metallic mesh material and the mortar are strongly integrated with each other after hardening of the fresh concrete, resulting in significant improvements in compressive strength, shearing strength, and bending strength of the hardened concrete.

The present inventor has made the following first to fourth modes of the present invention on the basis of the aforementioned findings.

### (First Mode of the Present Invention)

That is, a first mode of the present invention provides a metallic coarse aggregate for concrete including a coarse aggregate body including a spherical cap portion bonded body having two hollow spherical cap portions and an annular portion protruding from a surface of the spherical cap portion bonded body so as to surround an outer periphery of the spherical cap portion bonded body, the annular portion having a shape in which a corner of a rectangular shape is bent upward or downward.

Further, the first mode of the present invention provides, as a method for producing the above-described coarse aggregate for concrete, a method for producing a coarse aggregate for concrete including: performing press processing using a rectangular metal plate to form a spherical cap portion with flange having a rectangular flange at a bottom portion thereof; disposing the bottom portions of two spherical cap portions with flange so as to face each other; and pressure-bonding the flanges of the two spherical cap portions with flange to each other by press processing and bending a corner of a rectangular annular portion upward or downward.

According to the first mode of the present invention, the coarse aggregate body of the coarse aggregate for concrete, in which the spherical cap portion bonded body has a shape of sphere or a shape similar to sphere, exhibits high strength to compression and tension in any direction. Further, since the annular portion protrudes from the surface of the spherical cap portion bonded body so as to surround the outer periphery of the spherical cap portion bonded body, adhesive force between the coarse aggregate body and a mortar portion of concrete is improved. Further, since this annular portion is formed in a shape in which the corner of the rectangle is bent, the coarse aggregate is formed by press molding from a metal plate or a metal pipe without generating debris, and a die is also easily created. As a result, the coarse aggregate body can be produced with high productivity and at a low cost, therefore being useful as a building material that is consumed in large quantities.

### (Second Mode of the Present Invention)

A second mode of the present invention provides a metallic coarse aggregate for concrete including a plurality of spherical portions, and an annular portion protruding from the surface of the spherical portions so as to surround the outer periphery of the plurality of spherical portions. In such a coarse aggregate for concrete, the plurality of spherical portions are directly connected to each other, and the width of the coarse aggregate in a connection portion of the spherical portions on a surface formed by the outer edge of the annular portion is equal to or greater than the minimum diameter among the diameters of the plurality of spherical portions. In particular, the second mode of the present invention provides an aspect in which a flexible wire penetrates the spherical portion and protrudes from the annular portion or the spherical portion.

Further, the second mode of the present invention provides, as a method for producing the aforementioned metallic coarse aggregate for concrete, a method for producing a coarse aggregate for concrete including: performing press processing using a metal plate to form the spherical cap portions with flange in which bottom portions of the spherical cap portions are continued by the flange; and welding the flanges of two spherical cap portions with flange to each other. Further, the second mode of the present invention provides the method for producing a coarse aggregate for concrete in which the spherical portion and the annular portion are molded by press processing using a metal bar or a metal pipe.

Further, the second mode of the present invention provides, as a method for producing the aforementioned metallic coarse aggregate for concrete in the aspect in which the flexible wire penetrates the spherical portion and protrudes from the annular portion or the spherical portion, a method for producing a coarse aggregate for concrete including performing press processing using a metal plate to form the spherical cap portions with flange in which the bottom portions of the spherical cap portions are continued by the flange, disposing the bottom portions of two spherical cap portions with flange so as to face each other via the flexible wire, and welding the opposing flanges to each other; a method for producing a coarse aggregate for concrete including passing the flexible wire through inside a metal pipe, and performing press processing using the metal pipe through which the wire is passed to form the spherical portion and the annular portion such that the wire protrudes from the annular portion; and a method for producing a coarse aggregate for concrete including performing press processing using a metal bar or a metal pipe to form the spherical portion and the annular portion, making a through-hole in the spherical portion, and passing the flexible wire through the through-hole.

According to the second mode of the present invention, the coarse aggregate for concrete includes the plurality of spherical portions having a shape of sphere or a shape similar to sphere, the plurality of spherical portions are directly connected to each other, and the coarse aggregate has a sufficient width not only in the plurality of spherical portions but also in the connection portion therebetween. Thus, the coarse aggregate for concrete exhibits high strength to compression and tension in any direction. Further, the annular portion protrudes from the surface of the spherical portions so as to surround the outer periphery of the plurality of spherical portions, and thus the adhesive force between the coarse aggregate and a mortar portion of concrete is improved. This also improves strength of the concrete and facilitates uniform dispersion of the coarse aggregate in the fresh concrete. As a result, the concrete prepared by using the coarse aggregate for concrete of the present invention shows significant improvements in compressive strength and tensile strength. In spite of having a shape of sphere or a shape similar to sphere, the protruding annular portion reduces the tendency of rolling of the coarse aggregate, thereby improving handleability thereof. The plurality of spherical portions are surrounded by the annular portion and the width of the connection portion of the spherical portions is equal to or greater than the minimum diameter of the spherical portions.

Thus, the coarse aggregate can be easily molded by press processing using a metal plate with high productivity. The coarse aggregate can be produced at a low cost because a punching step for forming the connection portion can be omitted. Thus, the coarse aggregate is useful as a building material that is consumed in large quantities.

### (Third Mode of the Present Invention)

A third mode of the present invention provides a metallic coarse aggregate for concrete, which includes a coarse aggregate body including a spherical cap portion bonded body having two hollow spherical cap portions (hereinafter, sometimes simply referred to as a □spherical cap portion bonded body□) and an annular portion protruding from the surface of the spherical cap portion bonded body so as to surround the outer periphery of the spherical cap portion bonded body, and a plurality of flexible wires penetrating the spherical cap portion bonded body and protruding from the spherical cap portion bonded body or the annular portion. In such a coarse aggregate for concrete, the length of a protrusion portion of the wire (that is, when a part of the wire protruding outside the coarse aggregate body is bent, whether one end of the protrusion portion is held by the coarse aggregate body or both ends of the protrusion portion are held by the coarse aggregate body with the protrusion portion forming a loop, the length of the part of the wire protruding outside the coarse aggregate body when it is extended to a straight line in a state in which the end held by the coarse aggregate body remains held) is 1 to 5 times the maximum diameter of the spherical cap portion bonded body.

Further, the third mode of the present invention provides a method for producing the aforementioned metallic coarse aggregate for concrete in the aspect in which the wires protrude from the annular portion, that is, a method (i) including performing press processing using a metal pipe through which the plurality of flexible wires are passed, to form the spherical cap portion bonded body and the annular portion and to cause the plurality of flexible wires to protrude from the annular portion, and a method (ii) including performing press processing using a metal plate to form a spherical cap portion with flange having a flange at a bottom portion thereof, disposing the bottom portions of two spherical cap portions with flange so as to face each other as well as disposing the plurality of flexible wires between the spherical cap portions with flange so as to cross them, and pressure-bonding the flanges of the two spherical cap portions with flange to each other by press processing as well as holding the plurality of wires between the flanges.

Further, the third mode of the present invention provides a method for producing the coarse aggregate for concrete including a spherical cap portion bonded body having two hollow spherical cap portions and an annular portion protruding from the surface of the spherical cap portion bonded body so as to surround the entire outer periphery of the spherical cap portion bonded body. In such a production method, the spherical cap portion bonded body and the annular portion surrounding the entire outer periphery of the spherical cap portion bonded body are formed by press processing using a metal pipe. This production method has a significance as a production method of the spherical cap portion bonded body itself regardless of the presence/absence of the flexible wire.

Furthermore, the third mode of the present invention provides a metallic coarse aggregate for concrete which includes: a coarse aggregate body for concrete including a spherical cap portion bonded body having two hollow spherical cap portions and an annular portion protruding from the surface of the spherical cap portion bonded body so as to surround the outer periphery of the spherical cap portion bonded body; and a wire which is not adhered to the coarse aggregate body but is wound around the outer surface of the coarse aggregate body.

The third mode of the present invention also provides a metallic coarse aggregate for concrete which includes a coarse aggregate body for concrete including a spherical cap portion bonded body having two hollow spherical cap portions and an annular portion protruding from the surface of the spherical cap portion bonded body so as to surround the outer periphery of the spherical cap portion bonded body, and an outer fitting portion obtained by molding a bent wire into an annular shape so as to externally fit to the coarse aggregate body.

According to the third mode of the present invention, since the spherical cap portion bonded body has a shape of sphere or a shape similar to sphere, the coarse aggregate body of the coarse aggregate for concrete exhibits high strength to compression and tension in any direction. Further, in the coarse aggregate body, since the annular portion protrudes from the surface of the spherical cap portion bonded body so as to surround the outer periphery of the spherical cap portion bonded body, the adhesive force between the coarse aggregate body and a mortar portion of concrete is improved. Further, the spherical cap portion bonded body is made hollow and the plurality of flexible wires protrudes from the coarse aggregate body with the protrusion length of 1 to 5 times the maximum diameter among the diameters of the plurality of spherical cap portion bonded bodies. Thus, these wires are wound around the coarse aggregate body in a step of storage and conveyance of the coarse aggregate, preparation of the mortar, and the like, and the mortar is captured by the wound wires. Thus, the actual specific gravity of the coarse aggregate approaches that of the mortar. As a result, the coarse aggregate is less likely to be sedimented in the fresh concrete and dispersibility thereof in the concrete is improved. Accordingly, the concrete prepared by using the coarse aggregate of the present invention has significant improvements in compressive strength and tensile strength. Further, both in the coarse aggregate for concrete of the present invention in which the wire not adhered to the coarse aggregate body is wound around the outer surface of the coarse aggregate body and in the coarse aggregate for concrete of the present invention which includes the outer fitting portion obtained by molding the bent wire into an annular shape so as to externally fit to the coarse aggregate body, the adhesive force between the coarse aggregate body and a mortar portion of concrete is similarly improved. Furthermore, the coarse aggregate for concrete of the present invention can be produced with high productivity and at a low cost by press processing or the like using a metal plate or a metal pipe, and the wire. Therefore, the coarse aggregate for concrete of the present invention can be useful as a building material that is consumed in large quantities.

### (Fourth Mode of the Present Invention)

A fourth mode of the present invention provides a coarse aggregate for concrete which is obtained by molding a metallic woven net in a hollow shape.

According to the fourth mode of the present invention, when the coarse aggregate for concrete and the mortar are mixed, the mortar intrudes inside the coarse aggregate through a hole of mesh of the metallic woven net which is a metallic mesh material forming the outer surface of the coarse aggregate. Thus, the mortar enters the hole of the mesh of the metallic mesh material, whereby the metallic mesh material and the mortar are integrated with each other in a state of being strongly adhered to each other after the hardening of the fresh concrete. This can prevent the mortar portion integrated with the metallic mesh material from being peeled off from the metallic mesh material and thus being broken, even when a strong load is applied to the concrete. Accordingly, compressive strength, tensile strength, shearing strength, and bending strength of the concrete can be significantly improved.

### BRIEF DESCRIPTION OF DRAWINGS

### (First Mode of the Present Invention)

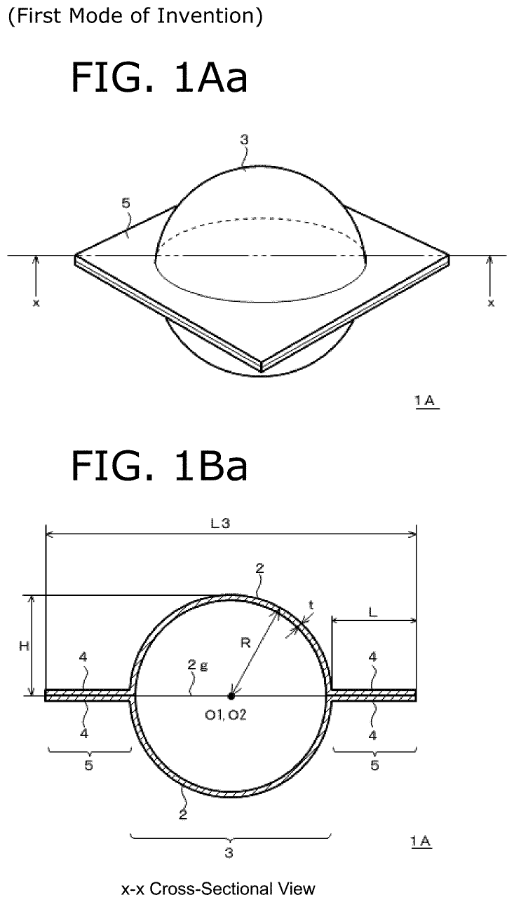

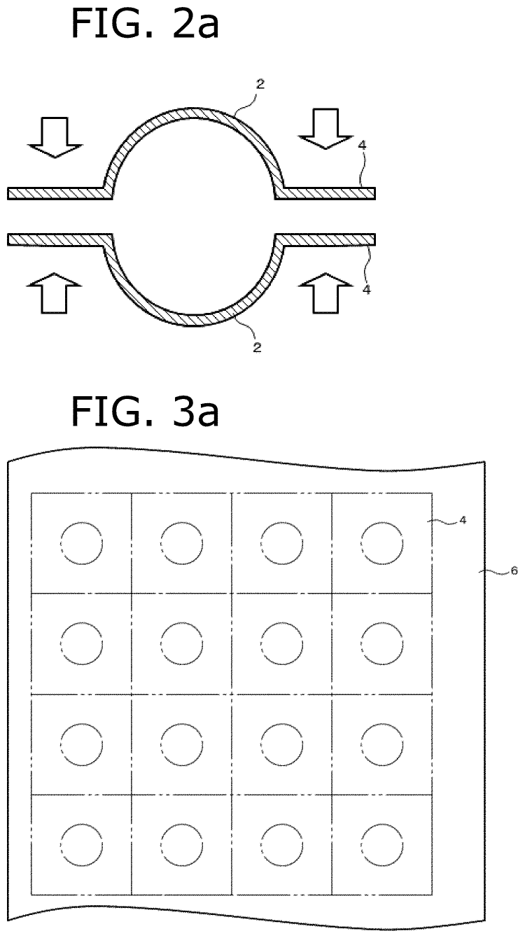

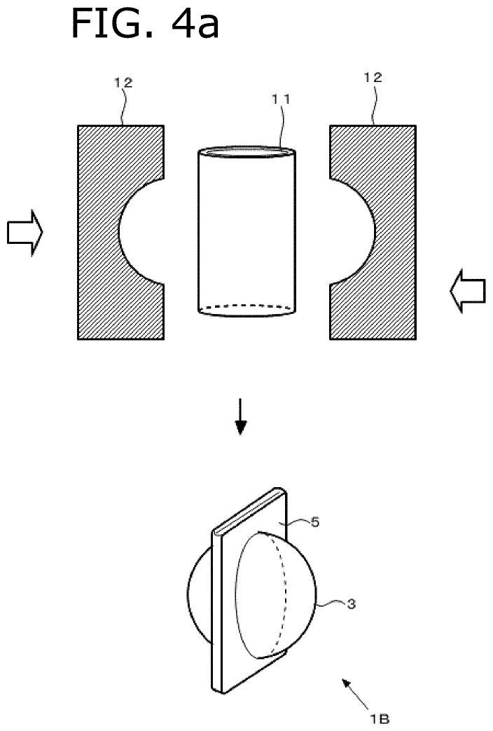

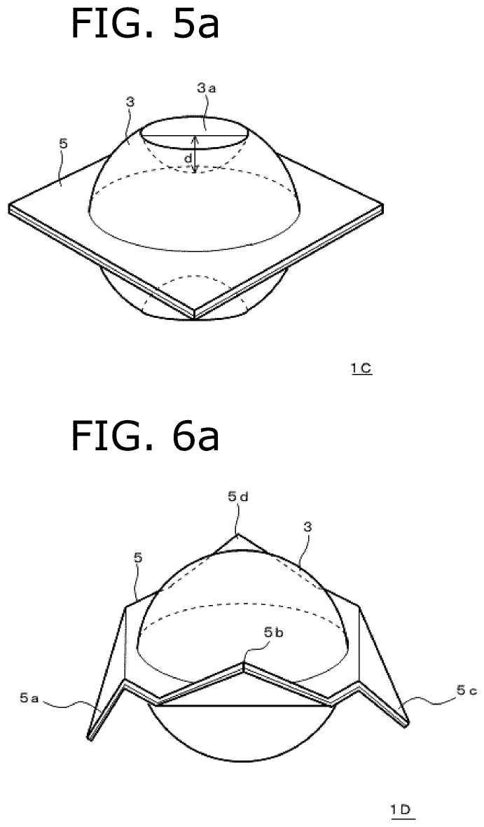

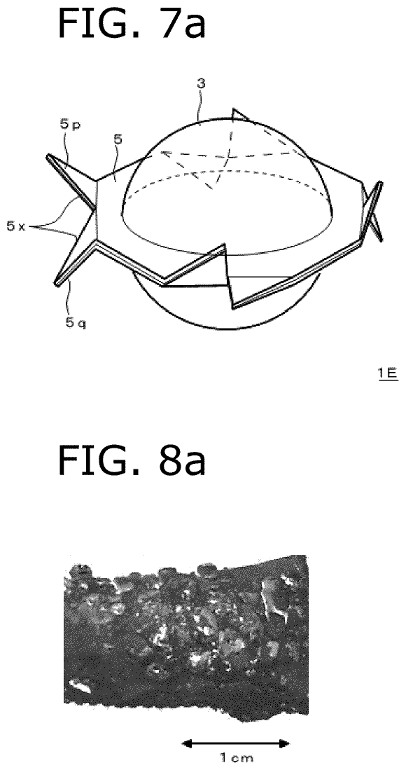

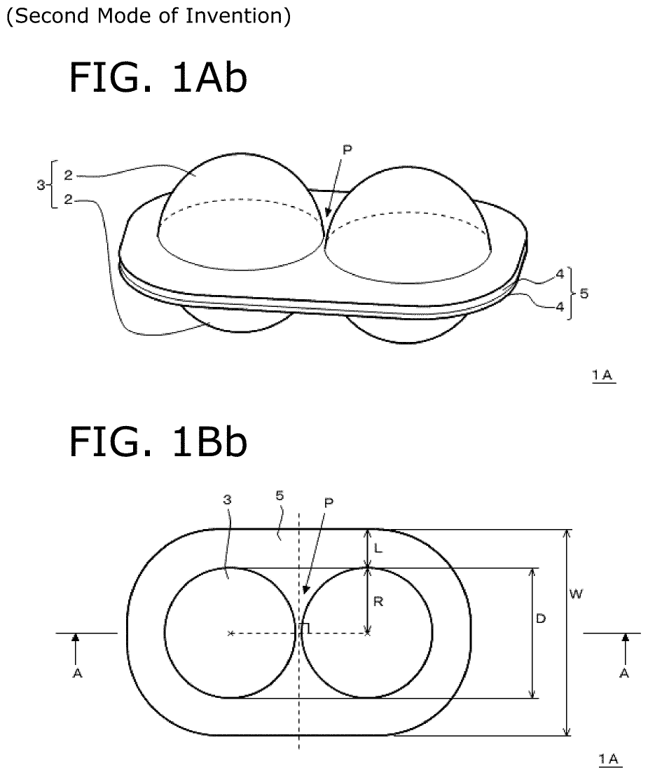

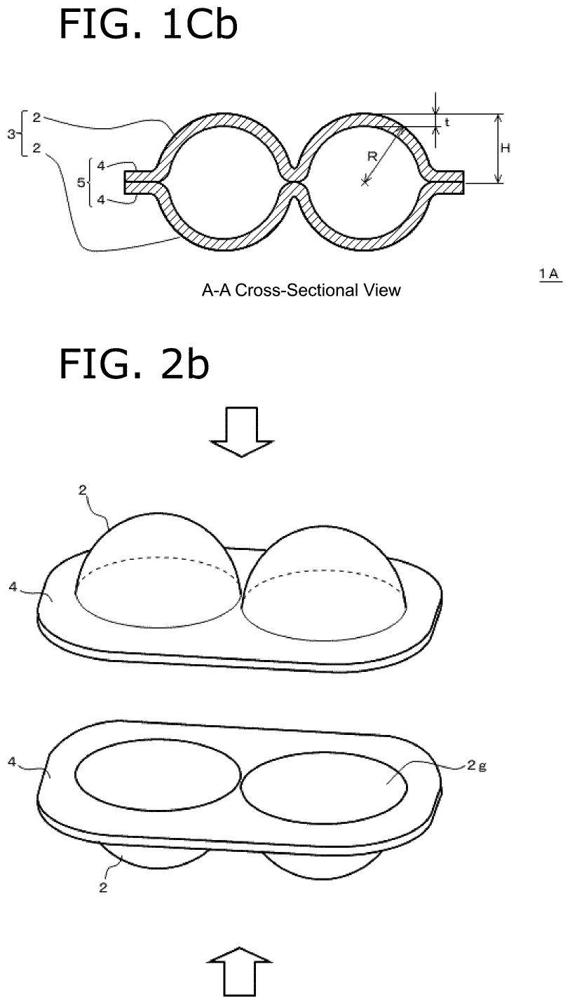

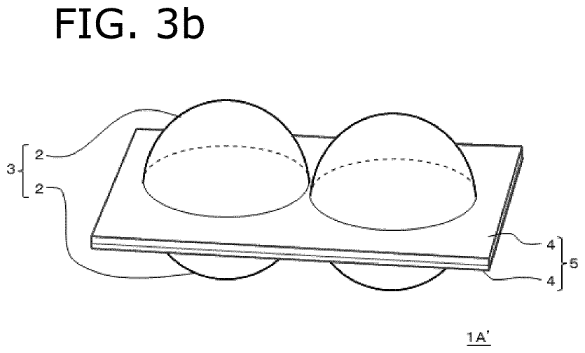

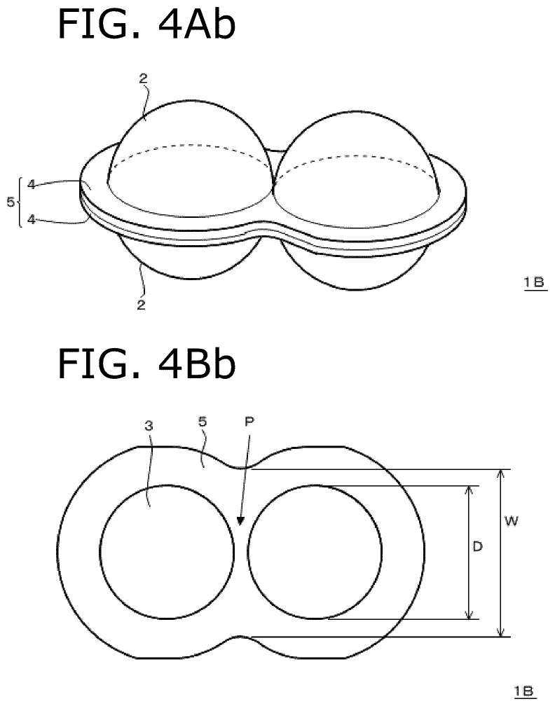

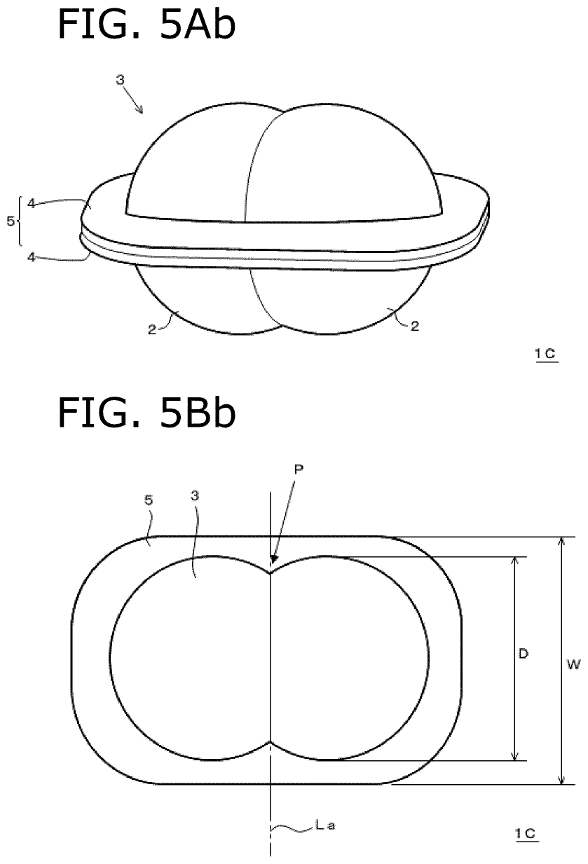

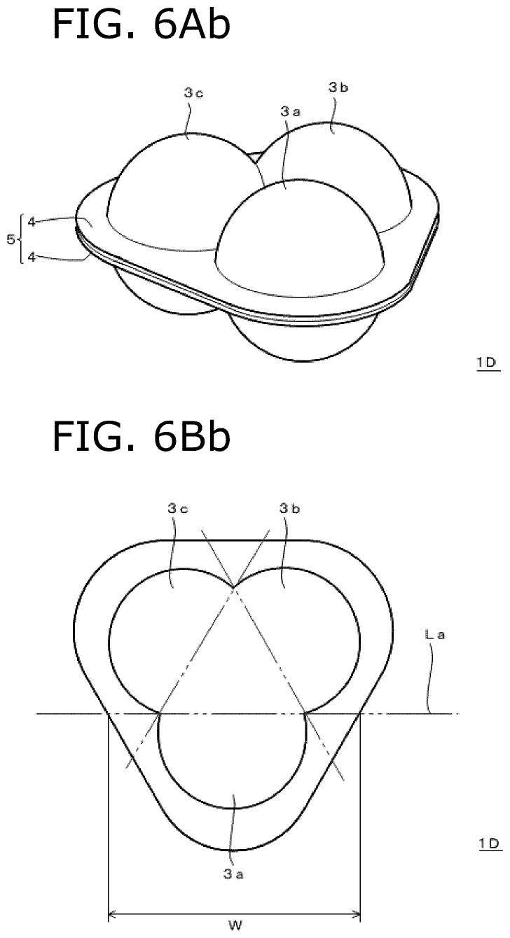

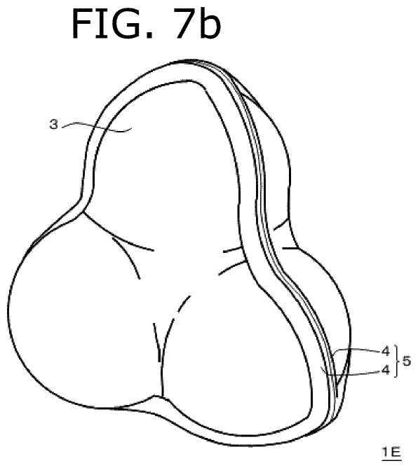

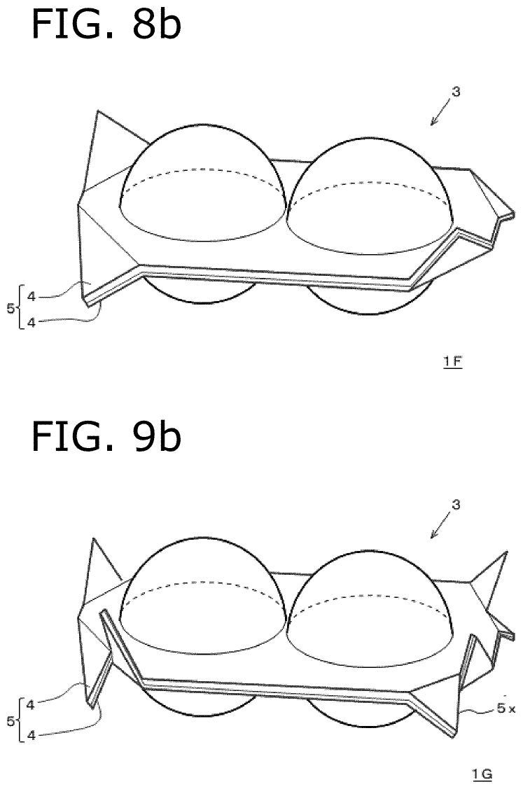

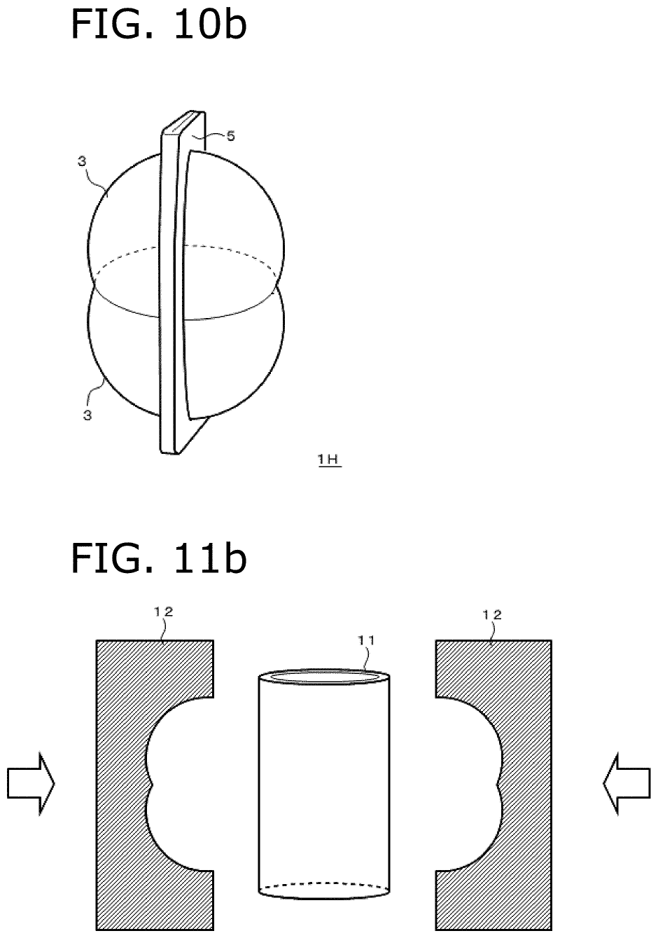

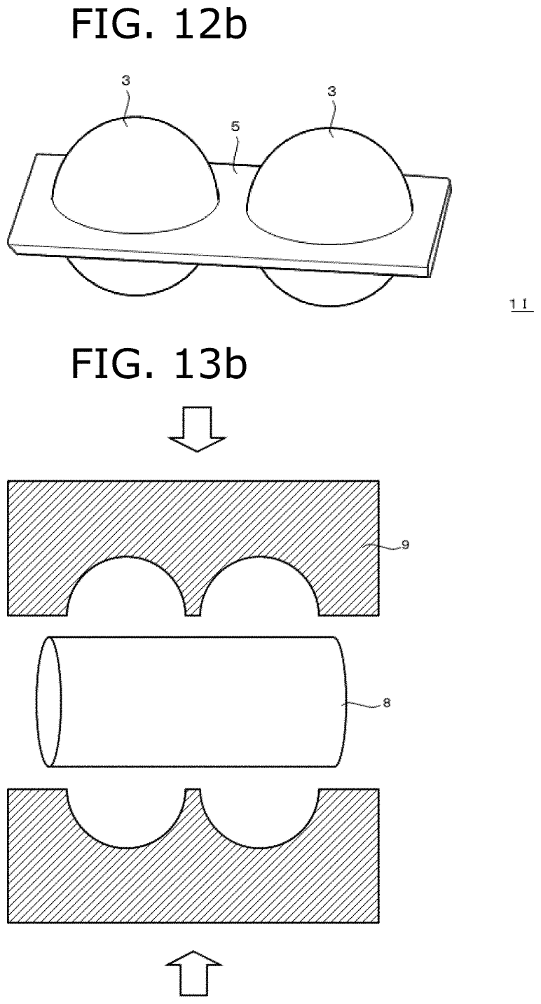

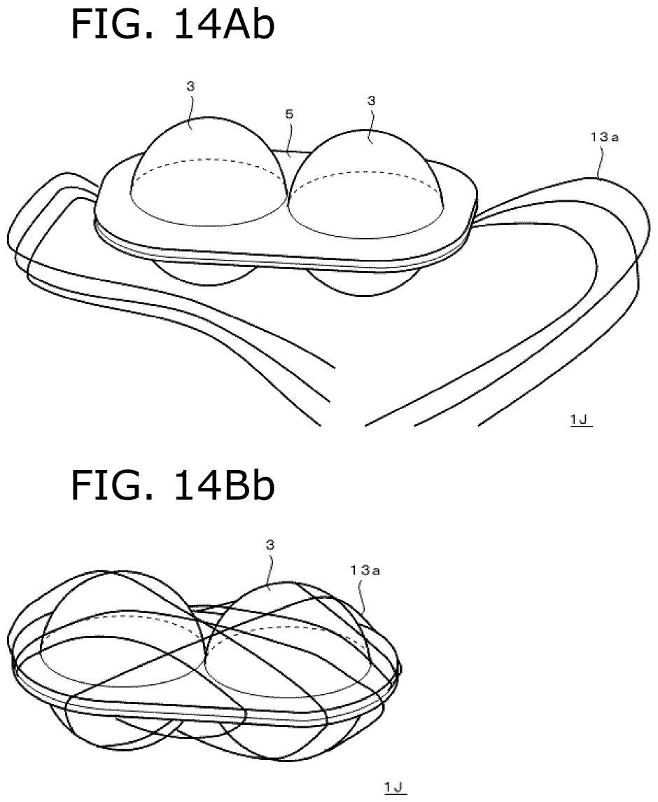

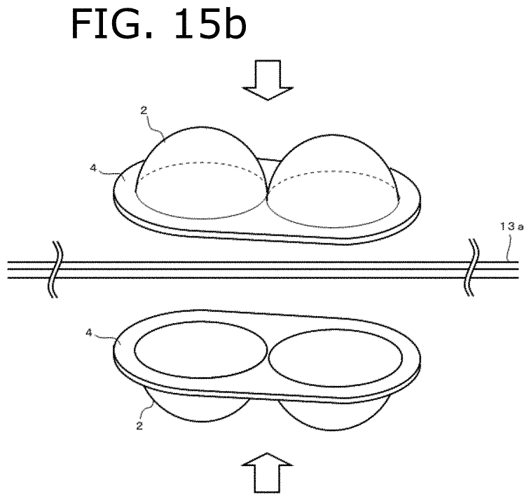

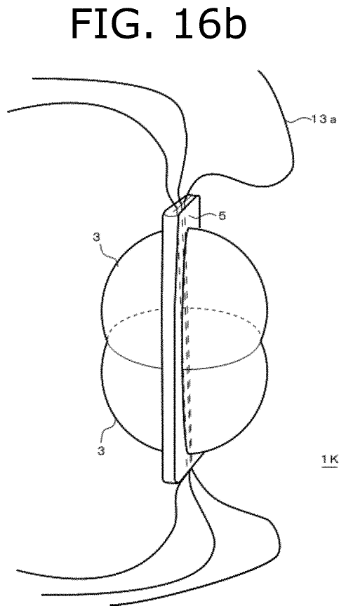

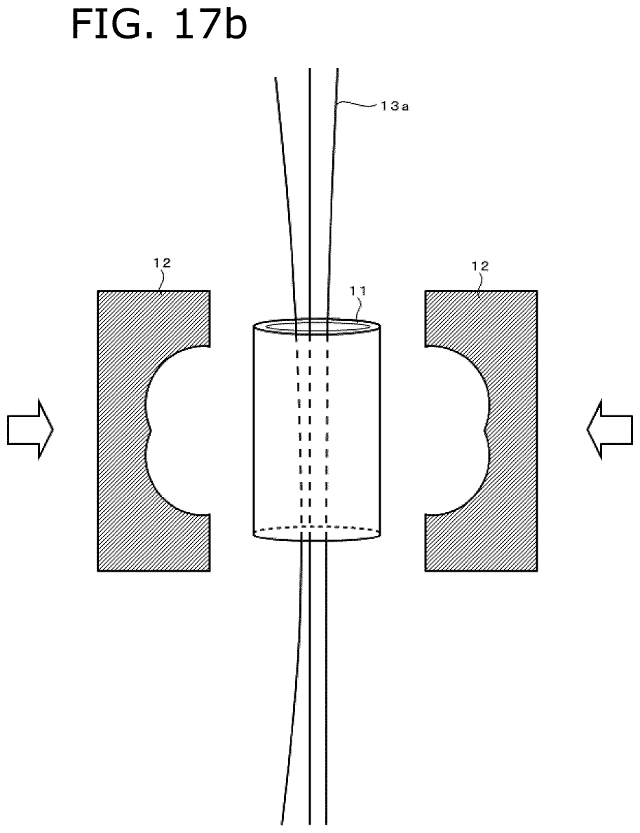

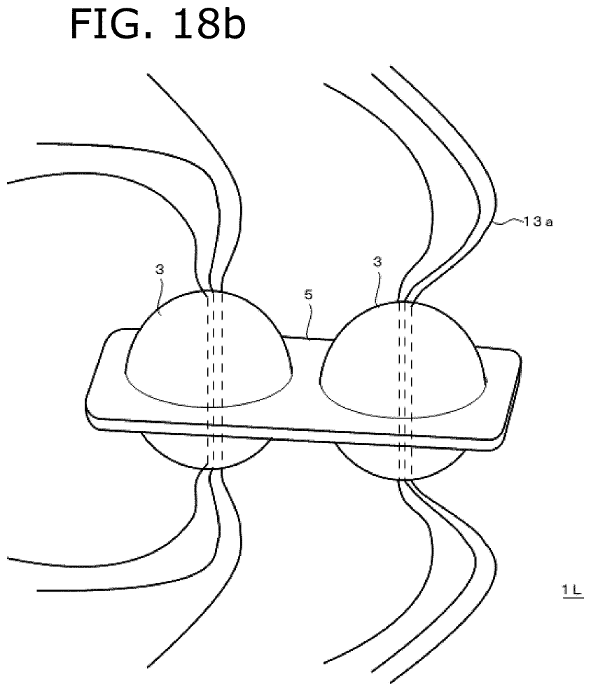

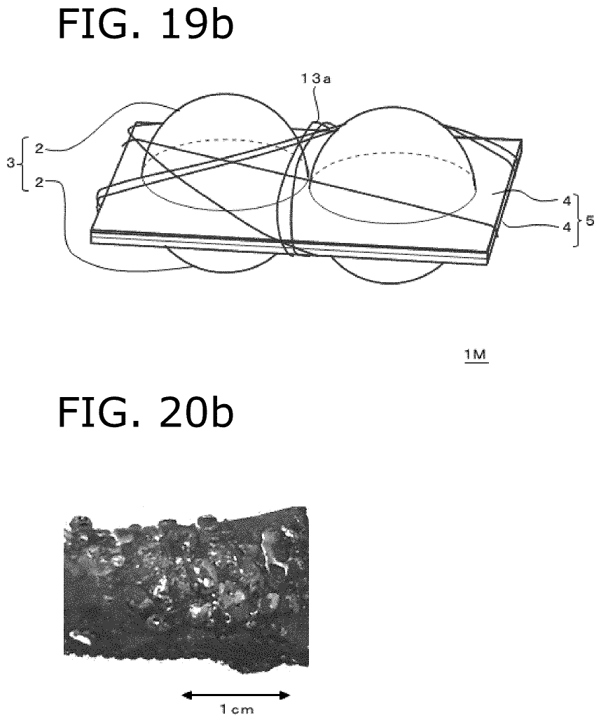

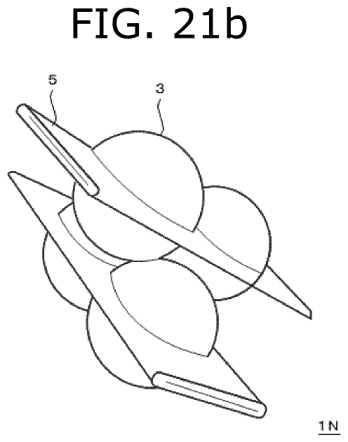

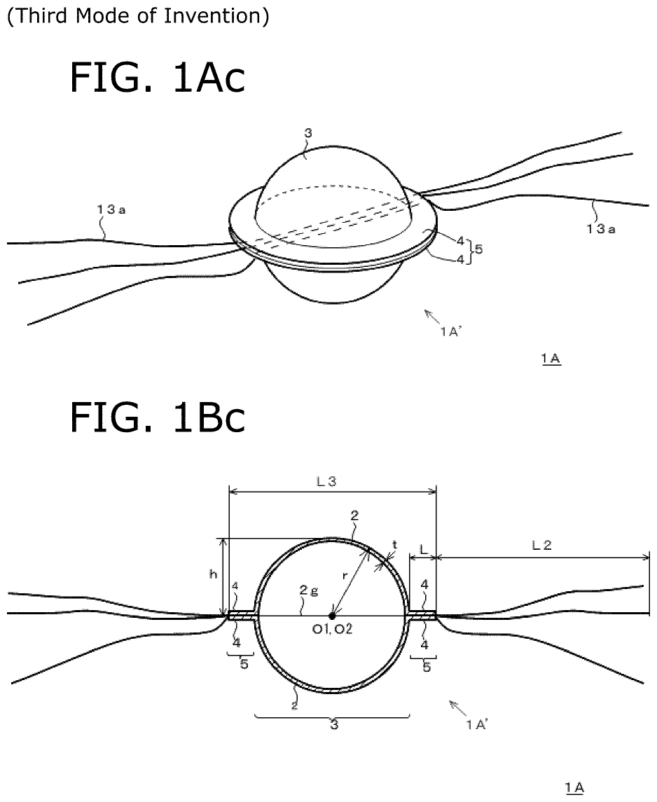

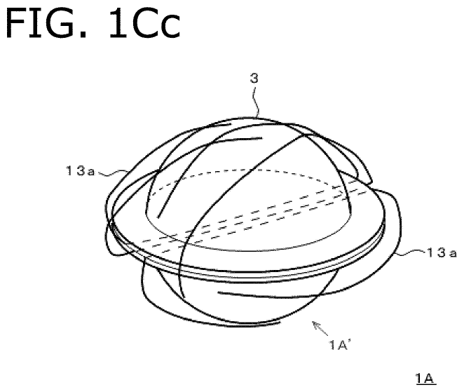

FIG. 1Aa is a perspective view of a coarse aggregate 1A for concrete of an example.

FIG. 1Ba is a cross-sectional view of the coarse aggregate 1A for concrete of the example.

FIG. 2a is an explanatory diagram of a method for producing the coarse aggregate 1A for concrete of the example.

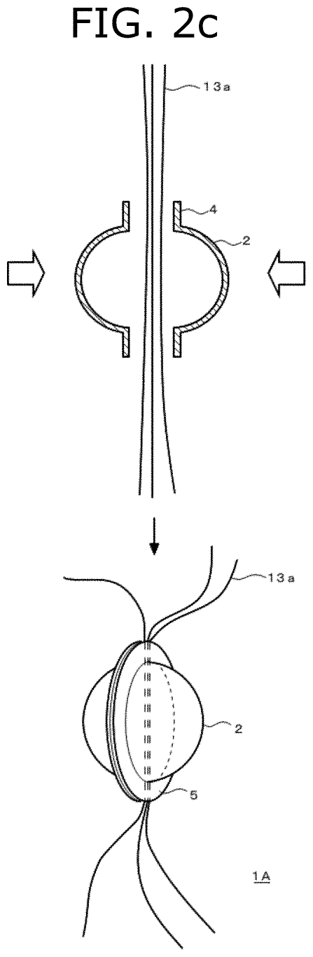

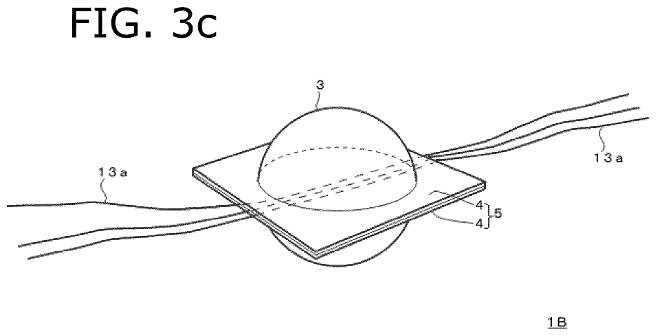

FIG. 3a is a plan view of a metal plate serving as a raw material for the coarse aggregate 1A for concrete of the example.

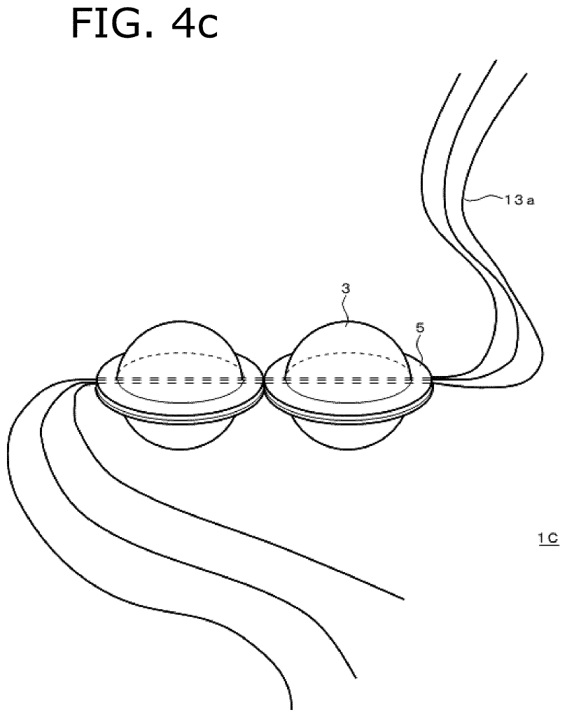

FIG. 4a is an explanatory diagram of a method for producing a coarse aggregate 1B for concrete of an example.

FIG. 5a is a perspective view of a coarse aggregate 1C for concrete of an example.

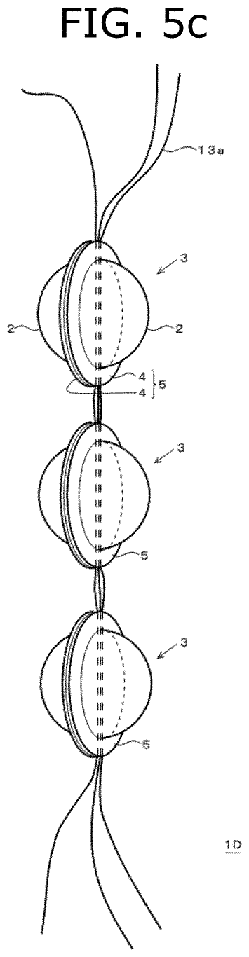

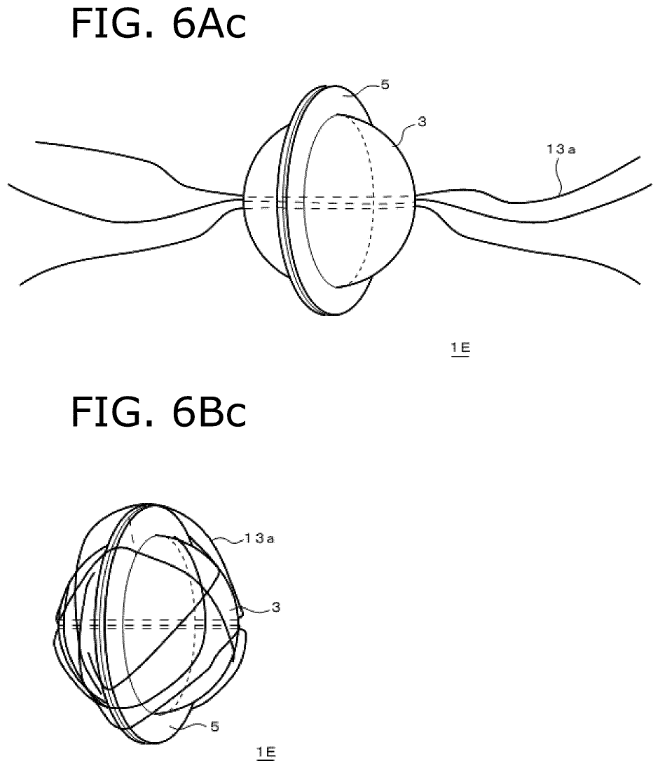

FIG. 6a is a perspective view of a coarse aggregate 1D for concrete of an example.

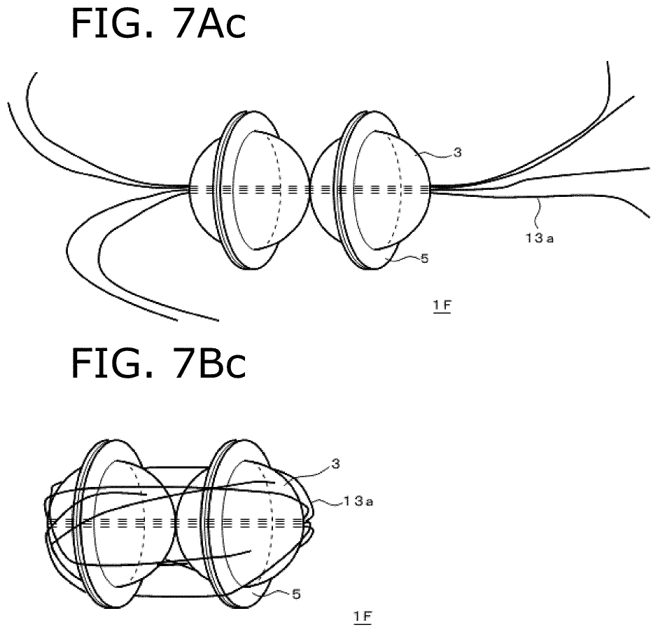

FIG. 7a is a perspective view of a coarse aggregate 1E for concrete of an example.

FIG. 8a is a photograph showing a surface of a metal aggregate to which molten metal droplets are welded.

### (Second Mode of the Present Invention)

FIG. 1Ab is a perspective view of a coarse aggregate 1A for concrete of an example.

FIG. 1Bb is a plan view of the coarse aggregate 1A for concrete of the example.

FIG. 1Cb is a cross-sectional view of the coarse aggregate 1A for concrete of the example.

FIG. 2b is an explanatory diagram of a method for producing the coarse aggregate 1A for concrete of the example.

FIG. 3b is a perspective view of a coarse aggregate 1A′ for concrete of an example.

FIG. 4Ab is a perspective view of a coarse aggregate 1B for concrete of an example.

FIG. 4Bb is a plan view of the coarse aggregate 1B for concrete of the example.

FIG. 5Ab is a perspective view of a coarse aggregate 1C for concrete of an example.

FIG. 5Bb is a plan view of the coarse aggregate 1C for concrete of the example.

FIG. 6Ab is a perspective view of a coarse aggregate 1D for concrete of an example.

FIG. 6Bb is a plan view of the coarse aggregate 1D for concrete of the example.

FIG. 7b is a perspective view of a coarse aggregate 1E for concrete of an example.

FIG. 8b is a perspective view of a coarse aggregate 1F for concrete of an example.

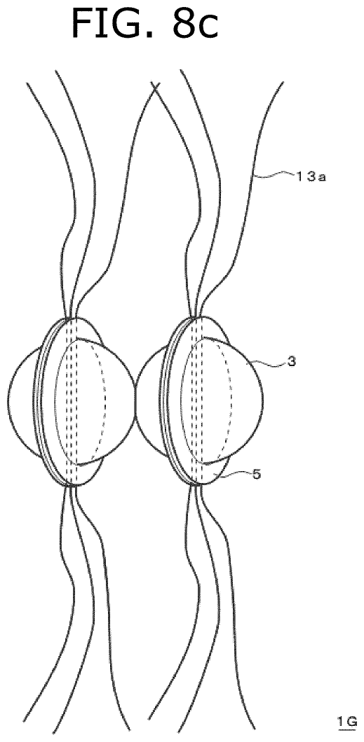

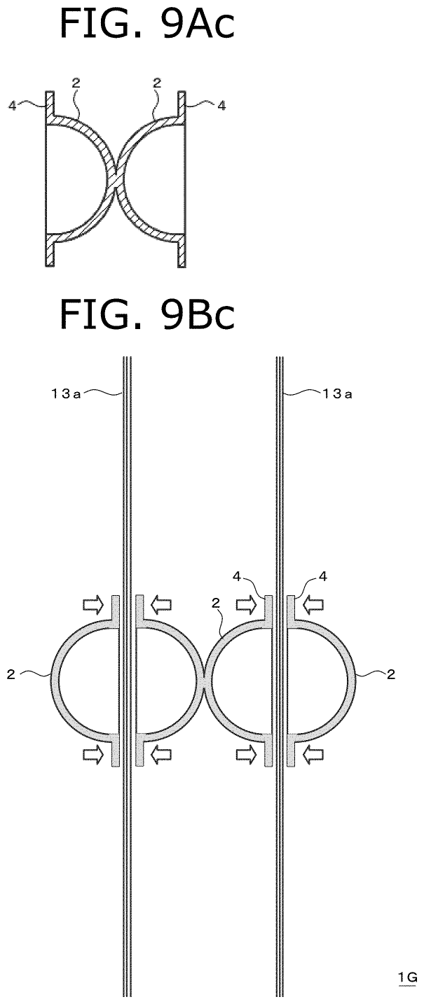

FIG. 9b is a perspective view of a coarse aggregate 1G for concrete of an example.

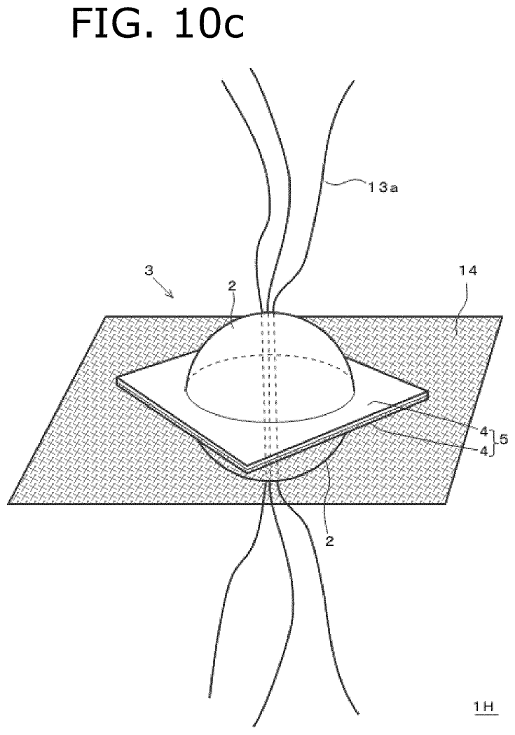

FIG. 10b is a perspective view of a coarse aggregate 1H for concrete of an example.

FIG. 11b is an explanatory diagram of a method for producing the coarse aggregate 1H for concrete of the example.

FIG. 12b is a perspective view of a coarse aggregate 1I for concrete of an example.

FIG. 13b is an explanatory diagram of a method for producing the coarse aggregate 1I for concrete of the example.

FIG. 14Ab is a perspective view of a coarse aggregate 1J for concrete of an example.

FIG. 14Bb is a perspective view of the coarse aggregate 1J for concrete of the example, illustrating a state in which wires are wound around a coarse aggregate body.

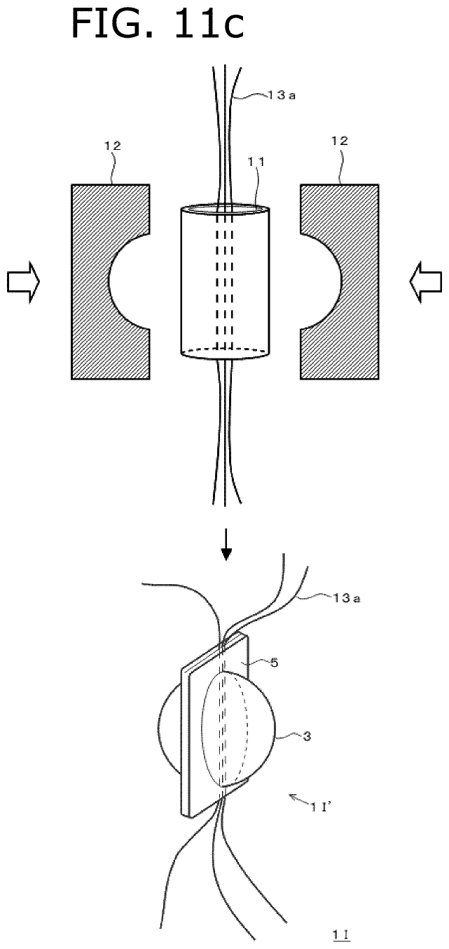

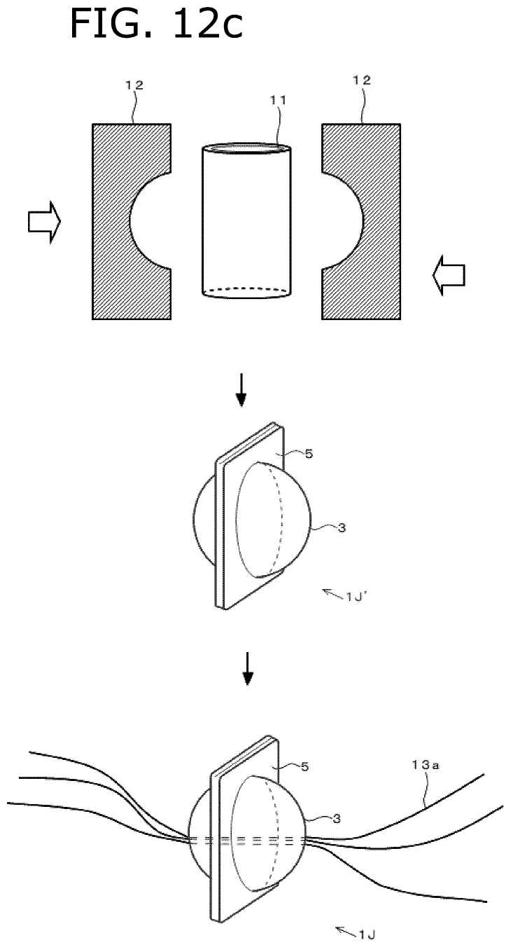

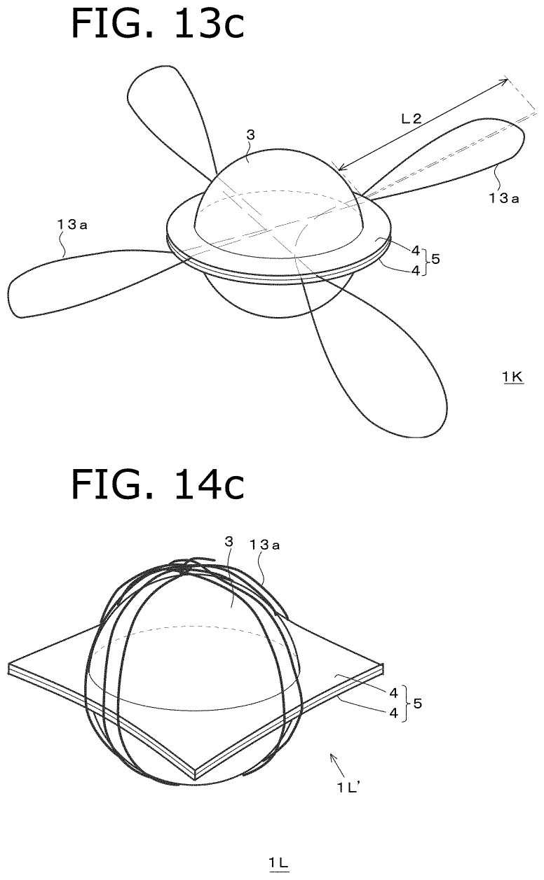

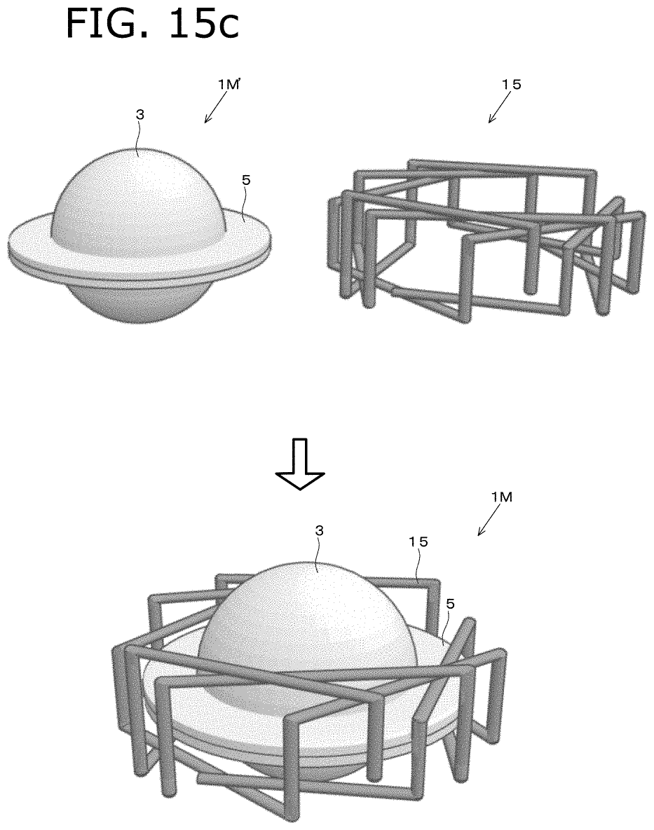

FIG. 15b is an explanatory diagram of a method for producing the coarse aggregate 1J for concrete of the example.

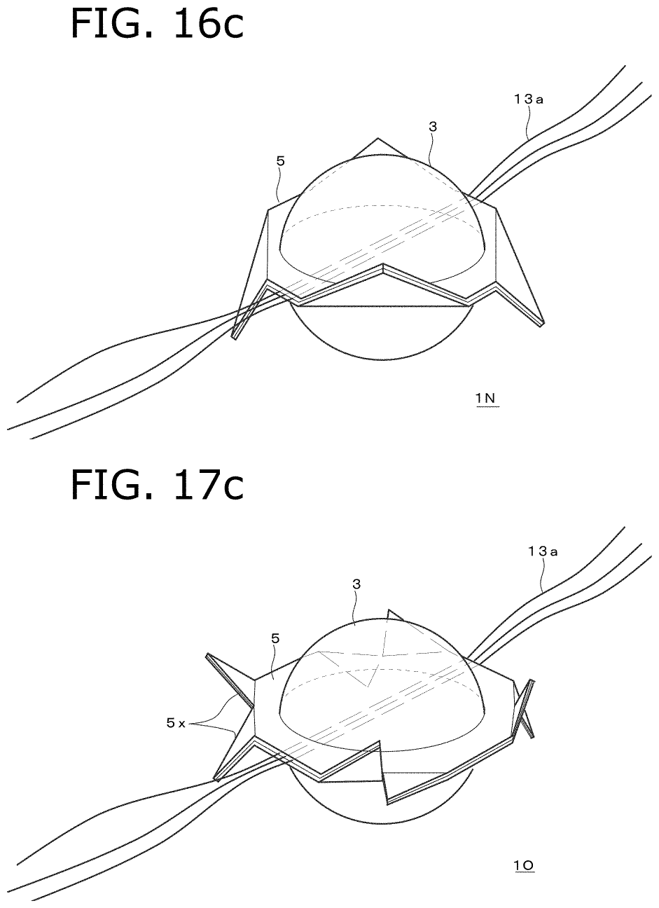

FIG. 16b is a perspective view of a coarse aggregate 1K for concrete of an example.

FIG. 17b is an explanatory diagram of a method for producing the coarse aggregate 1K for concrete of the example.

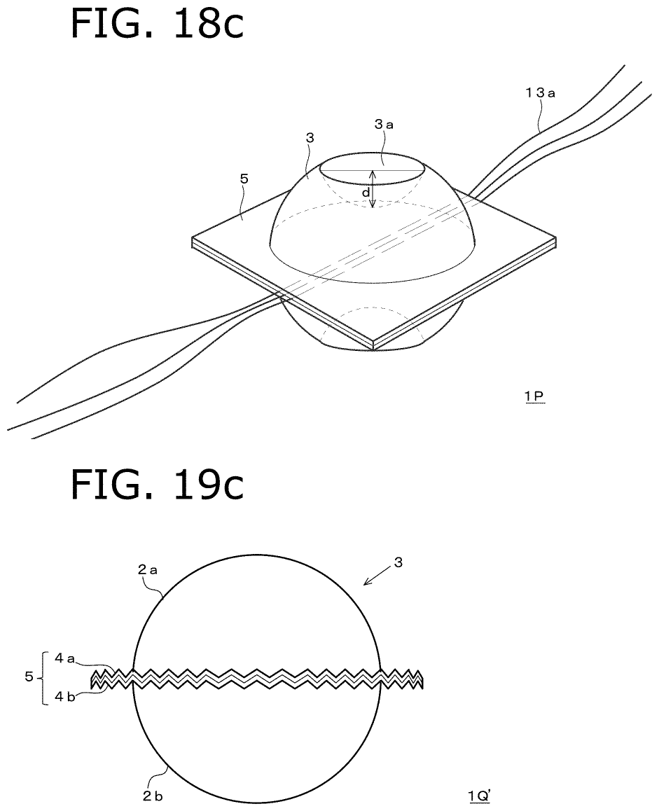

FIG. 18b is a perspective view of a coarse aggregate 1L for concrete of an example.

FIG. 19b is a perspective view of a coarse aggregate 1M for concrete of an example.

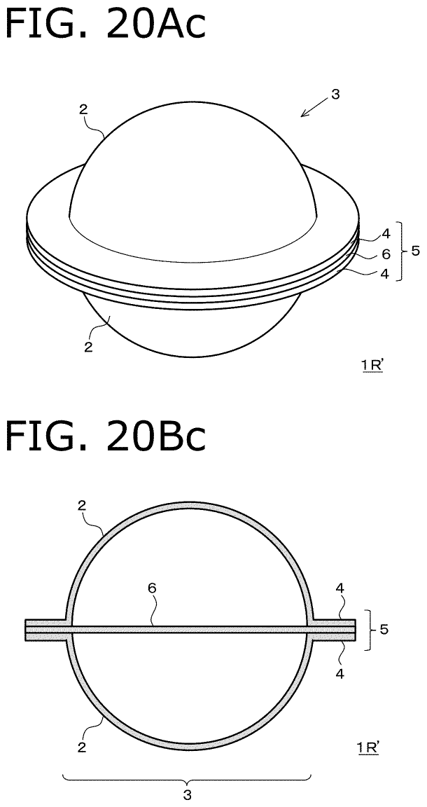

FIG. 20b is a photograph showing a surface of a metal aggregate to which molten metal droplets are welded.

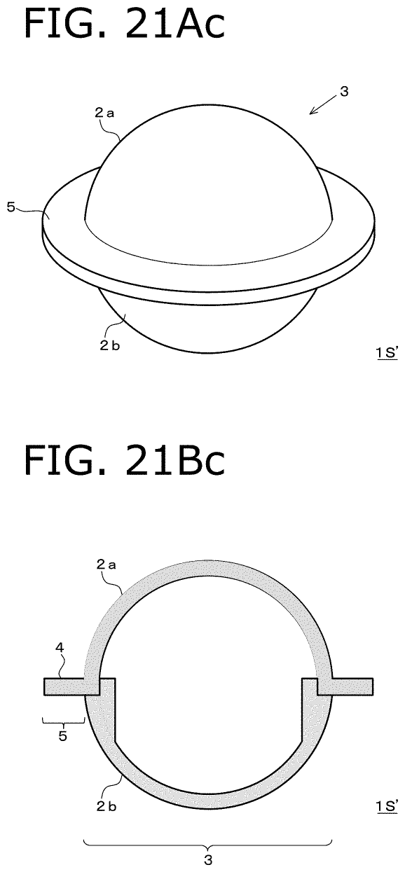

FIG. 21b is a perspective view of a coupling body 1N of coarse aggregates for concrete of the example.

### (Third Mode of the Present Invention)

FIG. 1Ac is a perspective view of a coarse aggregate 1A for concrete of an example.

FIG. 1Bc is a cross-sectional view of the coarse aggregate 1A for concrete of the example.

FIG. 1Cc is a perspective view of the coarse aggregate 1A for concrete of the example, illustrating a state in which wires are wound around a coarse aggregate body.

FIG. 2c is an explanatory diagram of a method for producing the coarse aggregate 1A for concrete of the example.

FIG. 3c is a perspective view of a coarse aggregate 1B for concrete of an example.

FIG. 4c is a perspective view of a coarse aggregate 1C for concrete of an example.

FIG. 5c is a perspective view of a coarse aggregate 1D for concrete of an example.

FIG. 6Ac is a perspective view of a coarse aggregate 1E for concrete of an example.

FIG. 6Bc is a perspective view of the coarse aggregate 1E for concrete of the example, illustrating a state in which wires are wound around a coarse aggregate body.

FIG. 7Ac is a perspective view of a coarse aggregate 1F for concrete of an example.

FIG. 7Bc is a perspective view of the coarse aggregate 1F for concrete of the example, illustrating a state in which wires are wound around a coarse aggregate body.

FIG. 8c is a perspective view of a coarse aggregate 1G for concrete of an example.

FIG. 9Ac is a cross-sectional view describing a method for producing the coarse aggregate 1G for concrete of the example.

FIG. 9Bc is a cross-sectional view describing a method for producing the coarse aggregate 1G for concrete of the example.

FIG. 10c is a perspective view of a coarse aggregate 1H for concrete of an example.

FIG. 11c is an explanatory diagram of a method for producing a coarse aggregate 1I for concrete of an example.

FIG. 12c is an explanatory diagram of a method for producing a coarse aggregate 1J for concrete of an example.

FIG. 13c is a perspective view of a coarse aggregate 1K for concrete of an example.

FIG. 14c is a perspective view of a coarse aggregate 1L for concrete of an example.

FIG. 15c is a perspective view of a coarse aggregate 1M for concrete of an example.

FIG. 16c is a perspective view of a coarse aggregate 1N for concrete of an example.

FIG. 17c is a perspective view of a coarse aggregate 1O for concrete of an example.

FIG. 18c is a perspective view of a coarse aggregate 1P for concrete of an example.

FIG. 19c is a side view of a coarse aggregate body 1Q′.

FIG. 20Ac is a perspective view of a coarse aggregate body 1R′.

FIG. 20Bc is a cross-sectional view of the coarse aggregate body 1R′.

FIG. 21Ac is a perspective view of a coarse aggregate body 1S′.

FIG. 21Bc is a cross-sectional view of the coarse aggregate body 1S′.

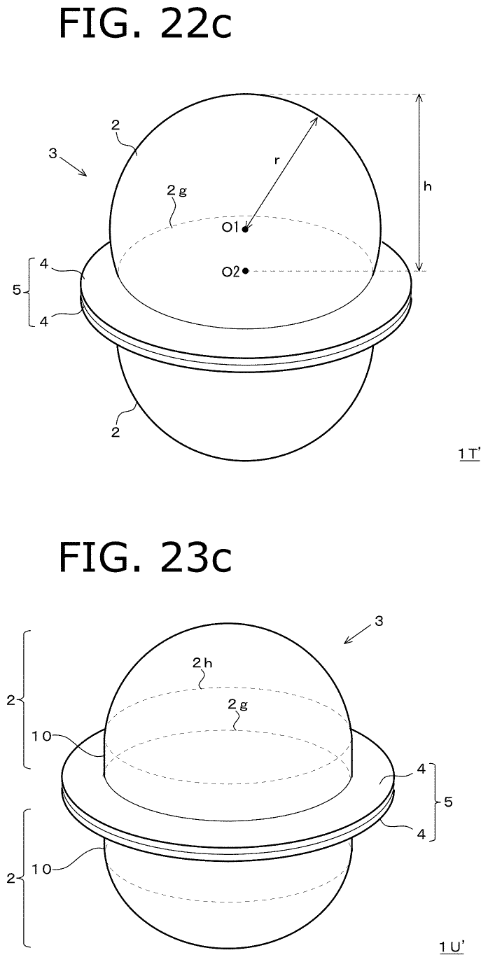

FIG. 22c is a perspective view of a coarse aggregate body 1T′.

FIG. 23c is a perspective view of a coarse aggregate body 1U′.

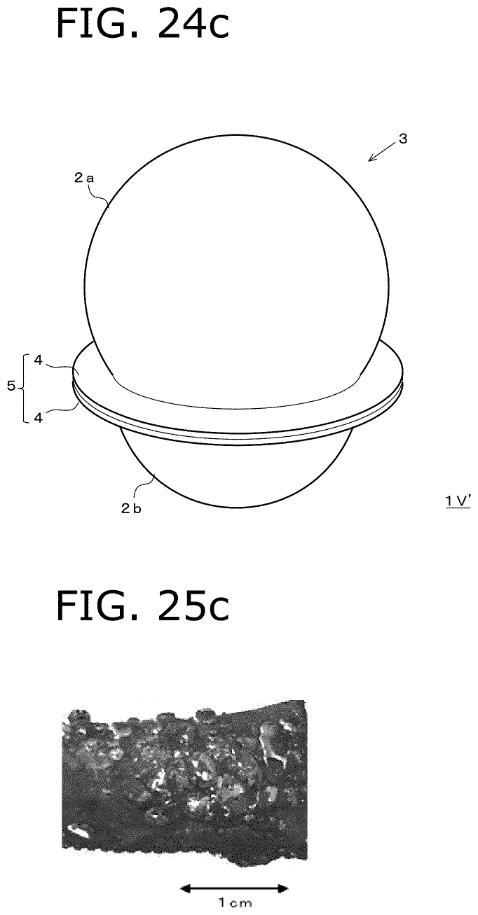

FIG. 24c is a perspective view of a coarse aggregate body 1V′.

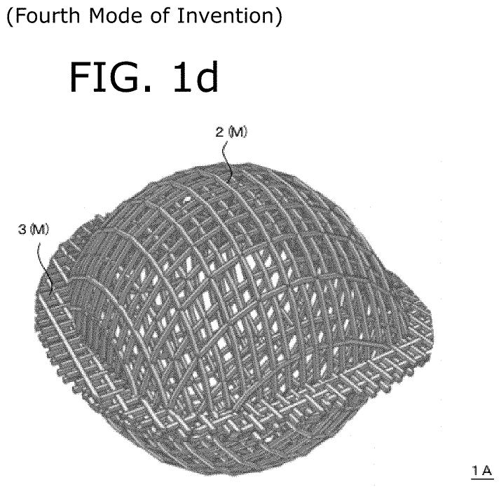

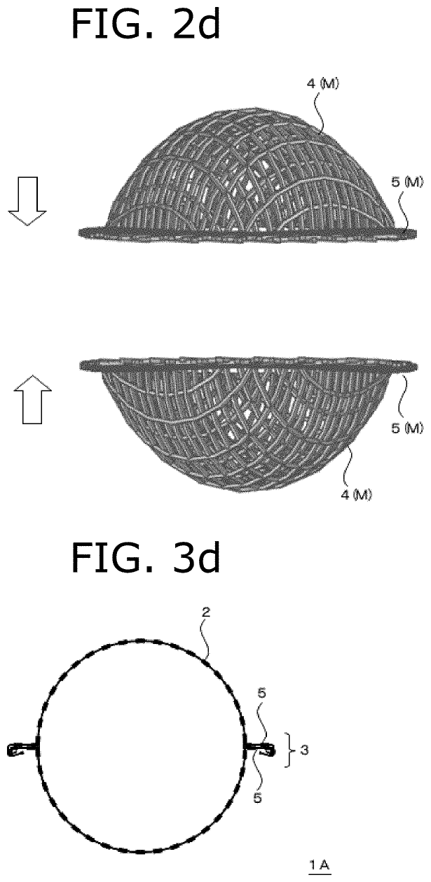

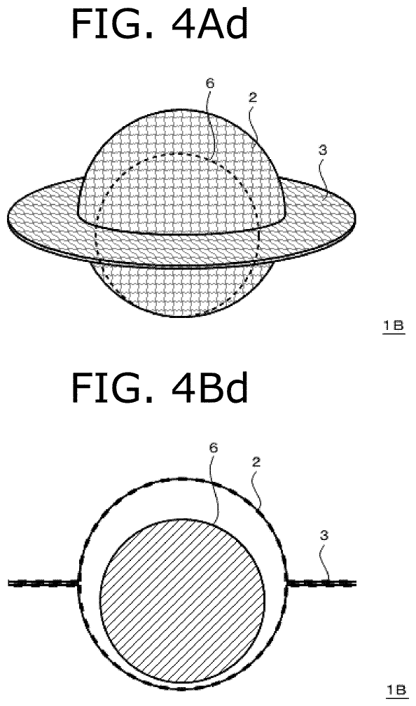

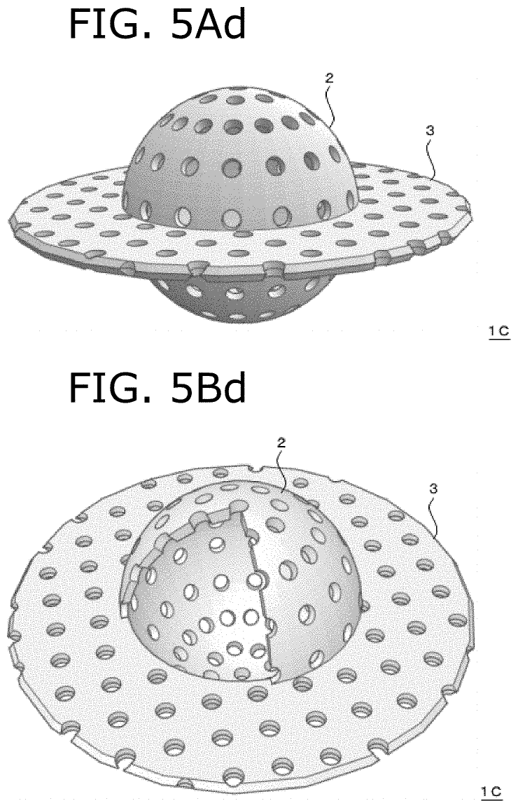

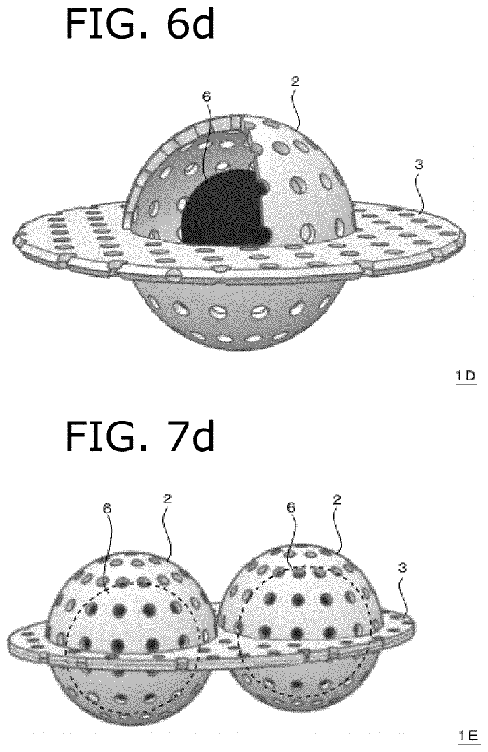

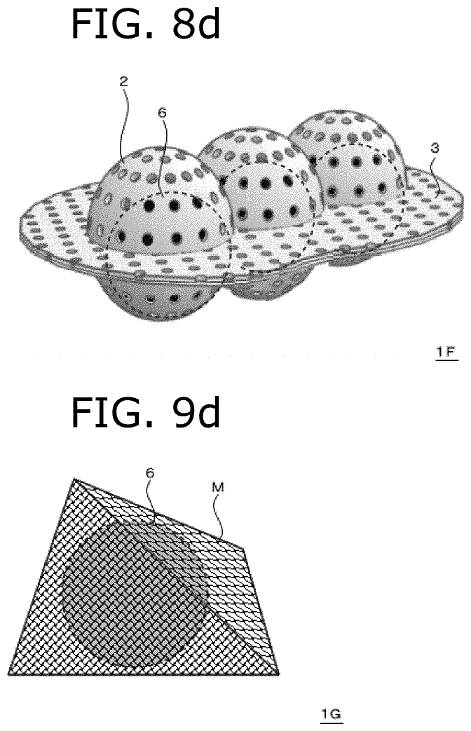

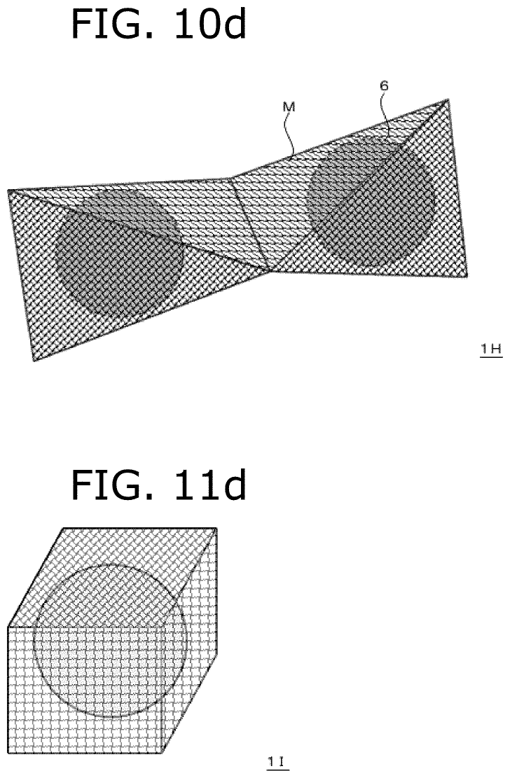

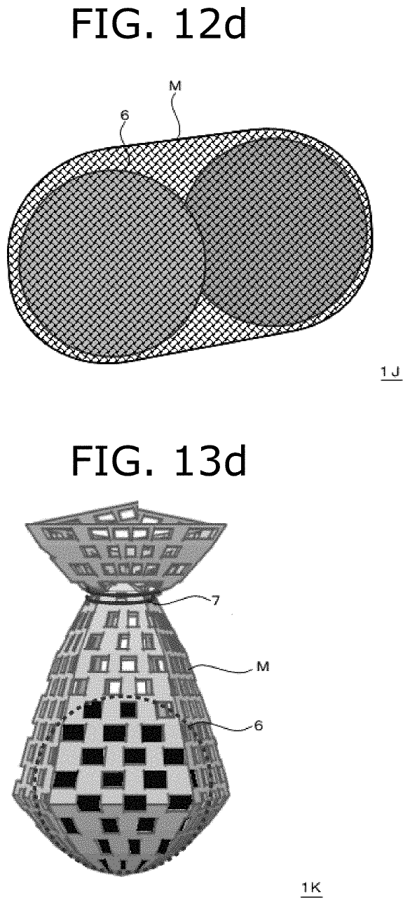

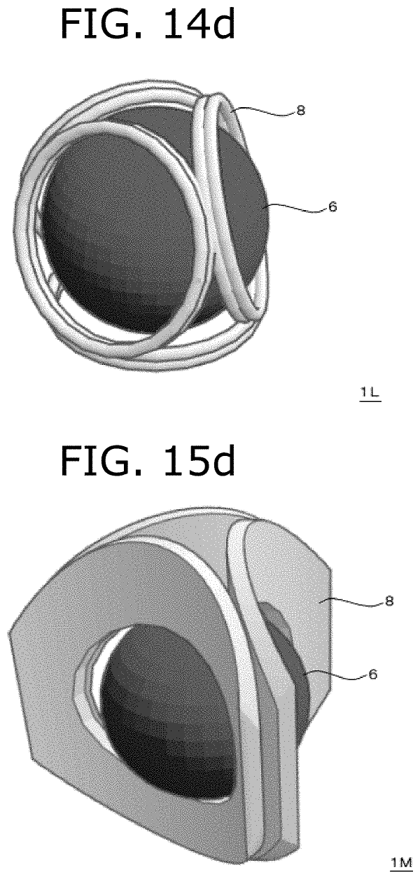

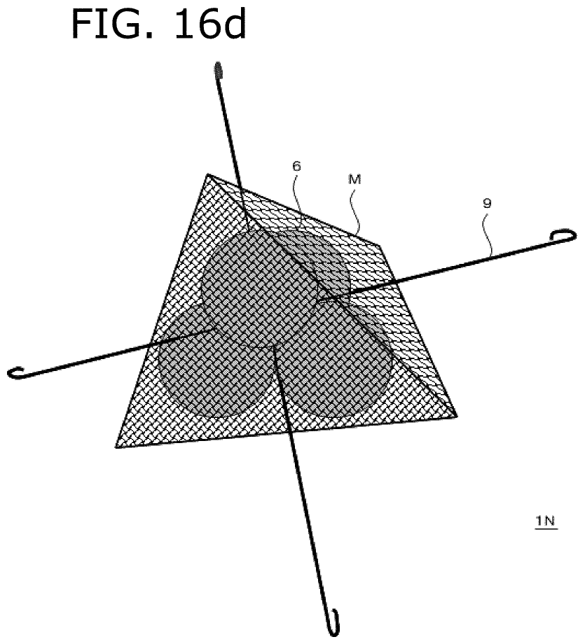

FIG. 25c is a photograph showing a surface of a metal aggregate to which molten metal droplets are welded.

### (Fourth Mode of the Present Invention)

FIG. 1d is a perspective view of a coarse aggregate 1A for concrete of an example.

FIG. 2d is an explanatory diagram of a method for producing the coarse aggregate 1A for concrete of the example.

FIG. 3d is a cross-sectional view of the coarse aggregate 1A for concrete of the example, illustrating a state in which the peripheral portion of a flange is caulked.

FIG. 4Ad is a perspective view of a coarse aggregate 1B for concrete of an example.

FIG. 4Bd is a cross-sectional view of the coarse aggregate 1B for concrete of the example.

FIG. 5Ad is a perspective view of a coarse aggregate 1C for concrete of an example.

FIG. 5Bd is a partially cut perspective view of the coarse aggregate 1C for concrete of the example.

FIG. 6d is a partially cut perspective view of a coarse aggregate 1D for concrete of an example.

FIG. 7d is a perspective view of a coarse aggregate 1E for concrete of an example.

FIG. 8d is a perspective view of a coarse aggregate 1F for concrete of an example.

FIG. 9d is a perspective view of a coarse aggregate 1G for concrete of an example.

FIG. 10d is a perspective view of a coarse aggregate 1H for concrete of an example.

FIG. 11d is a perspective view of a coarse aggregate 1I for concrete of an example.

FIG. 12d is a perspective view of a coarse aggregate 1J for concrete of an example.

FIG. 13d is a perspective view of a coarse aggregate 1K for concrete of an example.

FIG. 14d is a perspective view of a coarse aggregate 1L for concrete of an example.

FIG. 15d is a perspective view of a coarse aggregate 1M for concrete of an example.

FIG. 16d is a perspective view of a coarse aggregate 1N for concrete of an example.

### DESCRIPTION OF EMBODIMENTS

### (First Mode of the Present Invention)

Hereinafter, a coarse aggregate for concrete of the first mode of the present invention will be described in detail with reference to drawings. Note that, in the present mode, the same reference numerals represent the same or similar constituent elements in each drawing.

### (Shape of Coarse Aggregate)

FIG. 1Aa is a perspective view of a coarse aggregate 1A for concrete of an example of the first mode of the present invention and FIG. 1Ba is a cross-sectional view thereof. This coarse aggregate 1A is made of metal and includes a spherical cap portion bonded body 3 including two hollow spherical cap portions 2. The term □spherical cap□ described herein is a shape obtained by dividing a sphere with a cut plane, and the term □spherical cap portion□ refers to a portion of the coarse aggregate having such a shape.

In the present example, each spherical cap portion 2 preferably has a shape of spherical cap equal to or greater than a half of the sphere. In the coarse aggregate 1A of the present example, two opposing spherical cap portions 2 have a shape of hemisphere, and the radius R of a sphere of each spherical cap portion 2 is equal to the height H of the spherical cap portion 2. Further, the two spherical cap portions 2 are bonded symmetrically to each other across a bottom surface 2g of each spherical cap portion 2. Accordingly, the outer shape of this spherical cap portion bonded body 3 forms a spherical shape and the outer shape of the coarse aggregate as a whole also forms a substantially spherical shape. Thus, as compared with the coarse aggregate of which the outer shape is a polyhedral shape or an indeterminate three-dimensional shape, the coarse aggregate exhibits high strength to a plane load or a splitting tensile load applied from any direction. Note that, in FIG. 1Ba, a reference sign O1 denotes the center of the sphere and a reference sign O2 denotes the center of the bottom surface 2g of the spherical cap portion 2. In the coarse aggregate 1A of the present example, their positions overlap with each other.

In the coarse aggregate 1A, an annular portion 5 having a rectangular shape in plan view, which protrudes from the surface of the spherical cap portion bonded body 3 so as to surround the bottom portion of the spherical cap portion 2, is formed, and thus the spherical cap portion bonded body 3 and the annular portion 5 constitute the coarse aggregate 1A. This annular portion 5 is formed by bonding the rectangular annular flanges 4 formed around the outer peripheries of the bottom surfaces 2g of the respective spherical cap portions. The annular portion 5 is formed over the entire periphery of the spherical cap portion bonded body 3, and thus the coarse aggregate 1A has an approximate Saturn shape. The annular portion 5 protruding in this manner increases the adhesive force between the coarse aggregate 1A and the mortar when the coarse aggregate 1A is mixed with the mortar. Thus, along with the above-described strength improvement effect caused by the outer shape being a substantially spherical shape, the concrete prepared by using this coarse aggregate 1A instead of the conventional coarse aggregate has significant improvements in compressive strength and tensile strength.

Note that the coarse aggregate 1A of the present example includes the annular portion 5 having a shape of square in plan view. However, in the present invention, the outer shape of the annular portion 5 in plan view is not limited to the square, and it may be a rectangle.

As shown in FIG. 2a, the coarse aggregate 1A is obtained by performing press processing using a metal plate to mold the spherical cap portion 2, and bonding the flanges 4 of the spherical cap portions with the rectangular flanges 4 thus obtained to each other by press processing. In this case, as shown by a two-dot chain line in FIG. 3a, the flange 4 has a rectangular shape in plan view. Thus, when a part corresponding to one unit of the spherical cap portion with flange is punched out by press processing using a metal plate 6, it becomes possible to minimize generation of punched debris, thereby increasing productivity. As a result, the coarse aggregate has excellent mass productivity. Further, the flange 4 having a rectangular shape in plan view makes it easy to obtain a press head for punching out one unit of the spherical cap portion with flange.

### (Size of Coarse Aggregate)

In order to allow the fresh concrete in which the coarse aggregate 1A is blended to be pumped through a hose by pressure feeding, when the radius of the sphere of the spherical cap portion 2 is represented by R and the protrusion length (maximum length) of the annular portion 5 is represented by L, the maximum diameter ((R+L)×2) of the spherical cap portion bonded body 3 is preferably set to be approximately the same size as that of crushed gravel or stones of the conventional coarse aggregate. Specifically, the maximum diameter ((R+L)×2) of the coarse aggregate 1A is preferably set to be within a range of particle size and particle shape defined by JIS A 5308. In general, it is preferable that the diameter 2R of the sphere of the spherical cap portion 2 be set to be 10 mm to 30 mm, and the protrusion length L of the annular portion 5 be set to be ⅖ to 1 time the radius R of the sphere of the spherical cap portion 2. On the other hand, if the protrusion length L of the annular portion 5 is too small, when the annular portion 5 is formed by bonding to each other the flanges 4 formed outside the bottom portion of the spherical cap portion 2, it is difficult to strongly bond the flanges to each other. Further, when formation of the spherical cap portion bonded body by pressure-bonding of the spherical cap portions and insertion of the wire are not performed at the same time in the production method of the coarse aggregate, the spherical cap portion bonded body 3 is caused to excessively easily roll and thus handleability is deteriorated.

In the first mode of the present invention, the outer shape of the spherical cap portion bonded body 3 is a shape of sphere or a shape similar to sphere, and thus the height H of the spherical cap portion 2 is preferably equal to or greater than the radius R of the sphere of the spherical cap portion 2. In the coarse aggregate 1A of the present example, the height H of the spherical cap portion 2 is equal to the radius R of the sphere of the spherical cap portion 2.

### (Thickness of Spherical Cap Portion)

The thickness t of the spherical cap portion 2 can be determined in accordance with, for example, the kind of metal constituting the coarse aggregate 1A, the formation method of the shape of the spherical cap portion, and the use of the concrete prepared by using the coarse aggregate. For example, when the coarse aggregate is used in heavyweight concrete for radiation shield, the specific gravity of the coarse aggregate is preferably increased by increasing the thickness t of the spherical cap portion 2. There is no particular upper limitation on the thickness t. In this case, the spherical cap portion 2 can be produced by hot press.

On the other hand, when the coarse aggregate is used for the normal concrete and the spherical cap portion is formed by cold press, the spherical cap portion 2 having an excessively large thickness t makes it difficult to form the spherical cap portion by press processing, while the spherical cap portion 2 having an excessively small thickness t causes insufficient strength even when the coarse aggregate is used for the normal concrete. Thus, the thickness t of the spherical cap portion 2 is preferably set to be 1 mm to 6 mm.

### (Constituent Metal of Coarse Aggregate)

As the metal constituting the coarse aggregate 1A of the first mode of the present invention, iron, aluminum, titanium, copper, stainless steel, and the like can be mentioned, and the metal can be selected in accordance with the use of the concrete. For example, when the coarse aggregate is included in the heavyweight concrete used for shielding radiation in a nuclear facility or the like, the metal with high density such as iron is preferably used from the viewpoint of shielding X rays, γ rays, and the like. In order to perform production, conveyance, and the like of the coarse aggregate 1A itself or various concrete products including the coarse aggregate 1A by using an electromagnet, the coarse aggregate is preferably formed from a magnetic substance such as iron.

### (Production Method of Coarse Aggregate)

As a production method of the coarse aggregate 1A, first, the spherical cap portion 2 having the flange 4 at its bottom portion (that is, spherical cap portion with flange) is formed by press processing using a metal plate. Next, as shown in FIG. 2a, a pair of the spherical cap portions 2 with flange are disposed so as to face each other and the opposing flanges 4 are pressure-bonded to each other by press processing, followed by welding. The coarse aggregate 1A can be easily produced in this manner. Welding of the flanges 4 is preferably performed over the entire periphery thereof. On the other hand, the flanges 4 may be bonded to each other by caulking instead of welding the flanges 4 to each other.

### (Modified Aspect of Shape of Coarse Aggregate)

The coarse aggregate of the first mode of the present invention is made of metal and can take various shapes as long as it includes the spherical cap portion bonded body having two spherical cap portions and the rectangular annular portion formed around the outer periphery of the spherical cap portion bonded body. For example, as shown in FIG. 4a, a coarse aggregate 1B including the spherical cap portion bonded body 3 and the annular portion 5 can be obtained by subjecting a small piece 11 obtained by cutting a metal pipe to press processing with a die 12. The method for producing the coarse aggregate 1B by pressing the metal pipe as shown FIG. 4a enables mass production of the coarse aggregate with high productivity as compared with the production method in which the spherical cap portion with flange is first produced by pressing the metal plate and then the spherical cap portions with flange are pressure-bonded to each other.

In a coarse aggregate 1C shown in FIG. 5a, hemispherical recessed portions are formed on the top portions of the spherical cap portion bonded body 3 produced by pressing spherical press heads on both top portions of the spherical cap portion bonded body 3 in the coarse aggregate 1A shown in FIG. 1Aa. Formation of the recessed portions 3a on the top portions of the spherical cap portion bonded body 3 in this manner can further improve the adhesive force of mortar to the coarse aggregate 1C. Further, such press processing performed on the top portions of the spherical cap portion bonded body 3 can be performed simultaneously with the press processing of the pair of flanges 4, thereby not resulting in a reduction in productivity of the coarse aggregate.

Note that the depth d of the recessed portion 3a is preferably set to be ⅓ to ½ the radius R of the spherical cap portion bonded body 3.

In a coarse aggregate 1D shown in FIG. 6a, the corners of the rectangular annular portion 5 of the coarse aggregate 1A shown in FIG. 1Aa are alternately bent upward or downward. The annular portion 5 of which corners are bent in this manner can further improve the adhesive force of mortar to the coarse aggregate 1D. Further, the bending of the annular portion 5 can be performed simultaneously with the press processing for pressure-bonding the pair of the flanges 4, thereby not resulting in a reduction in productivity of the coarse aggregate 1D.

In a coarse aggregate 1E shown in FIG. 7a, bent pieces 5p, 5q which are bent upward or downward alternately in each corner of the rectangular annular portion 5 are formed in the coarse aggregate 1A shown in FIG. 1Aa. More specifically, a cut 5x is made from the vertex of each corner of the rectangular annular portion 5 toward the center of the coarse aggregate, and both sides thereof are bent upward or downward. Cutting and bending the annular portion 5 in this manner can also further improve the adhesive force of mortar to the coarse aggregate 1E. Further, such cutting and bending of the annular portion 5 can be performed simultaneously with the pressure-bonding of the pair of flanges 4 by pressing, thereby not resulting in a reduction in productivity of the coarse aggregate 1E.

### (Surface Processing of Coarse Aggregate Body)

In the first mode of the present invention, in order to improve the adhesion of mortar, molten metal droplets generated by a sputtering phenomenon of various welding types are welded to a part or the whole, preferably the whole, of the surface of the coarse aggregate body, so that the surface can be roughened by the metal particle welded to the surface. According to this method, as compared with a case where the surface of the coarse aggregate is roughened simply by irradiating the surface with electron beam or the like, the metal droplets generated by melting an electrode bar are adhered to the surface of the coarse aggregate body without reducing the thickness of the coarse aggregate body, and thus the adhesion of mortar to the coarse aggregate body can be improved without reducing the strength of the coarse aggregate body.

In particular, it is preferable that arc discharge be performed using an electrode preferably with heating, and the molten metal droplets generated from the electrode be welded to the surface of the coarse aggregate body under heating. In this manner, as seen in the metal surface shown in FIG. 8a, the entire surface of the coarse aggregate body can be roughened by a welded substance of the molten metal droplets. Note that welding of the molten metal droplets using arc discharge to the surface of the coarse aggregate body can be performed with high productivity and at a low cost.

Further, instead of welding of the molten metal droplets of the electrode bar to the coarse aggregate body by arc discharge as described above, welding of the molten metal droplets of the electrode bar may be performed by applying arc discharge or the like in advance to a metal plate, a metal pipe, or a metal bar to be used at the time of producing the coarse aggregate.

Note that the modified aspects of the first mode of the present invention described above can be appropriately combined with one another.

### (Application Example of Coarse Aggregate)

The coarse aggregate for concrete of the first mode of the present invention can partially or wholly replace the coarse aggregate in the blending composition of the conventional concrete. As a preferable application example of the coarse aggregate for concrete of the first mode of the present invention, as a concrete precast product, for example, the hollow coarse aggregate of the first mode of the present invention can be used to produce a light-weight ferroconcrete plate that is highly resistant to compression and tension. The coarse aggregate for concrete can be preferably used for a concrete construction without a reinforcing bar (e.g., a dam wall, a road set directly on the ground, a mat foundation for a construction, and a paved place). As a specialized application example, the coarse aggregate for concrete can be preferably used for a ferroconcrete floor slab for an express-highway set at a position apart from the ground, or the like. Further, when the coarse aggregate for concrete of the first mode of the present invention is constituted from a magnetic material, conveyance, installation, and removal of a panel can be performed through attraction to an electromagnet, and thus workability is improved.

### (Second Mode of the Present Invention)

Hereinafter, a coarse aggregate for concrete of the second mode of the present invention will be described in detail with reference to drawings. Note that, in the present mode, the same reference numerals represent the same or similar constituent elements in each drawing.

### (Shape of Coarse Aggregate)

FIG. 1Ab is a perspective view of a coarse aggregate 1A for concrete of an example of the second mode of the present invention, FIG. 1Bb is a plan view thereof, and FIG. 1Cb is a cross-sectional view taken along line A-A. This coarse aggregate 1A is made of metal and configured such that two spherical cap portion bonded bodies (i.e., spherical portions) 3 each including two hollow spherical cap portions 2 are disposed side by side. The term □spherical cap□ described herein is a shape obtained by dividing a sphere with a cut plane, and the term □spherical cap portion□ refers to a portion of the coarse aggregate having such a shape. Note that, in the second mode of the present invention, the shape of each spherical cap portion 2 preferably includes a spherical cap equal to or greater than a half of the sphere. In the coarse aggregate 1A of the present example, the shape of each spherical cap portion 2 is a hemispherical shape. Thus, the outer shape of the spherical portion 3 of the coarse aggregate 1A forms a spherical shape, and, as a result, as compared with a case where the outer shape is a polyhedral shape or an indeterminate three-dimensional shape, the coarse aggregate 1A exhibits high strength to a plane load or a splitting tensile load applied from any direction.

In the coarse aggregate 1A, the annular portion 5 protruding from the surface of the spherical portions 3 so as to surround the outer periphery of two spherical portions 3 on the plane including the bottom surface 2g of each spherical cap portion 2 is formed. As shown in FIG. 2b, this annular portion 5 is produced by preparing a pair of components in which the flange 4 is continuously formed along the outer periphery of the bottom surfaces 2g of two spherical cap portions disposed side by side, and bonding the flanges 4 of these components to each other. The annular portion 5 is formed along the entire periphery of the two spherical portions 3.

The two spherical portions have an equal diameter D, and the width W of the coarse aggregate in a connection portion P of the two spherical portions 3 on the plane formed by the outer edge of the annular portion 5 is equal to or greater than the diameter D of the spherical portions 3. Here, in a case where the two spherical portions 3 are away from each other as shown in FIG. 1Bb, the width W of the coarse aggregate in the connection portion P is defined by the shortest of the lengths of the coarse aggregate in a direction passing through the gap of the two spherical portions 3 and perpendicular to a line connecting the centers of the two spherical portions 3. In this coarse aggregate 1A, this length of the width is equal to or greater than the diameter D of the spherical portions 3, and thus the coarse aggregate 1A can be easily produced by press processing as described below. Further, the tensile strength of the coarse aggregate 1A in the connection portion P is not excessively reduced, and the concrete prepared by using this coarse aggregate 1A has a significant improvement in tensile strength as the two spherical portions 3 of the coarse aggregate 1A serve as an anchor.

Further, according to this coarse aggregate 1A, the annular portion 5 increases the adhesive force between the coarse aggregate 1A and the mortar when the coarse aggregate 1A and the mortar are mixed. Thus, along with the above strength improvement effect caused by the two spherical portions 3 included in the coarse aggregate 1A, the concrete prepared by using this coarse aggregate 1A instead of the conventional coarse aggregate has significant improvements in compressive strength and tensile strength.

Note that, although two spherical portions have the equal diameter in the coarse aggregate 1A of the present example, when two spherical portions have a different diameter, the width W of the coarse aggregate in the connection portion P is equal to or greater than the smaller diameter. Further, in the coarse aggregate 1A of the present example, the outer shape of the annular portion 5 in plan view is a rectangular shape having rounded corners. However, the outer shape of the annular portion 5 in the present invention is not limited thereto, and, for example, the annular portion 5 may have a rectangular shape as seen in a coarse aggregate 1A′ shown in FIG. 3b. This makes it possible to easily produce a die used for punching out the spherical cap portion with flange using a metal plate and reduce debris generated when the spherical cap portion with flange is punched out using a metal plate, thereby improving productivity of the coarse aggregate. On the other hand, the annular portion may have an oval shape, and, as seen in a coarse aggregate 1B shown in FIG. 4Ab and FIG. 4Bb, the width of the connection portion P may be slightly narrowed. However, even in this coarse aggregate 1B, the width W of the coarse aggregate in the connection portion P is equal to or greater than the minimum diameter D of the spherical portion 3. Note that the upper limit of the width W of the coarse aggregate in the connection portion P is defined by the upper limit of the size of the coarse aggregate described below.

### (Size of Coarse Aggregate)

In order to allow the fresh concrete in which the coarse aggregate 1A is blended to be pumped through a hose by pressure feeding, the maximum diameter of the coarse aggregate 1A is preferably set to be approximately the same size as that of gravel or crushed stones of the conventional coarse aggregate. Specifically, the maximum diameter of the coarse aggregate 1A is preferably set to fall within a range of particle size and particle shape defined by JIS A 5308. For this purpose, in general, the diameter D of the spherical portion 3 is preferably set to be 10 to 30 mm and the protrusion length L of the annular portion 5 in the radial direction of the sphere of the spherical cap portion 2 is preferably set to be ⅖ to 1 time the radius R of the sphere of the spherical cap portion 2. On the other hand, when the protrusion length L of the annular portion 5 is too small, the adhesive force between the coarse aggregate and the mortar is reduced and the coarse aggregate 1A is caused to excessively easily roll. Thus, handleability is deteriorated. Further, when the annular portion 5 is formed by bonding to each other the flanges 4 formed outside the bottom portions of the spherical cap portions 2, if the protrusion length L of the annular portion 5 (that is, the protrusion length of the flange 4) is too small, it becomes difficult to strongly bond the flanges 4 to each other.

In the coarse aggregate 1A of the present example, the height H of the spherical cap portion 2 is equal to the radius R of the sphere of the spherical cap portion 2. In the second mode of the present invention, the height H of the spherical cap portion 2 is preferably set to be equal to or greater than the radius R of the sphere of the spherical cap portion 2 in order to allow the outer shape of the coarse aggregate 1A to include the spherical portion 3 having a shape of sphere or a shape similar to sphere. On the other hand, when the height H is too high, it sometime becomes difficult to pump the concrete through a hose by pressure feeding. Thus, the height H of the spherical cap portion 2 is preferably set to be 1.5 times or less the radius R of the sphere of the spherical cap portion 2.

### (Thickness of Spherical Cap Portion)

In the second mode of the present invention, the thickness t of the spherical cap portion 2 (that is, a thickness of the spherical portion 3) can be determined in accordance with, for example, the kind of metal constituting the coarse aggregate 1A, the formation method of the shape of the spherical cap portion, and the use of the concrete prepared by using the coarse aggregate. For example, when the coarse aggregate is used in heavyweight concrete for radiation shield, the specific gravity of the coarse aggregate is preferably increased by increasing the thickness t of the spherical cap portion 2. There is no particular upper limitation on the thickness t. A hollow portion may not be substantially formed inside the coarse aggregate. In this case, the spherical cap portion 2 can be produced by hot press.

On the other hand, when the coarse aggregate is used for the normal concrete and the spherical cap portion is formed by cold press, the spherical cap portion 2 having an excessively large thickness t makes it difficult to form the spherical cap portion by press processing, while the spherical cap portion 2 having an excessively small thickness t causes insufficient strength even when the coarse aggregate is used for the normal concrete. Thus, the thickness t of the spherical cap portion 2 is set to be preferably 1 to 6 mm, more preferably 2 to 4 mm.

### (Constituent Metal of Coarse Aggregate)

As the metal constituting the coarse aggregate 1A of the second mode of the present invention, iron, aluminum, titanium, copper, stainless steel, and the like can be mentioned, and the metal can be selected in accordance with the use of the concrete. For example, when the coarse aggregate is included in the heavyweight concrete used for shielding radiation in a nuclear facility or the like, the metal with high density such as iron is preferably used from the standpoint of shielding X rays, γ rays, and the like. In order to perform production, conveyance, and the like of the coarse aggregate 1A itself or various concrete products including the coarse aggregate 1A by using an electromagnet, the coarse aggregate is preferably formed from a magnetic substance such as iron.

### (Production Method of Coarse Aggregate)

The coarse aggregate 1A of the present example can be easily produced through press processing using a metal plate as shown in FIG. 2b by producing a pair of the spherical cap portions with flange in which two spherical cap portions are continued by the flanges 4 protruding from the bottom portions of the spherical cap portions, disposing them so as to face each other, and bonding the flanges 4 to each other by welding. In the present invention, the width of the coarse aggregate in the connection portion of the spherical portions is set to be equal to or greater than the minimum diameter of the spherical portion, and thus it is not necessary to perform cutting processing for adjusting the outer shape of the coarse aggregate after welding of the flanges 4, allowing simplification of the production step.

Welding of the flanges 4 is preferably performed over the entire periphery of the flanges 4. On the other hand, the flanges 4 may be bonded to each other by caulking instead of welding.

Note that, in the second mode of the present invention, the production method of the coarse aggregate is not limited to press processing using a metal plate, and, as described below, the coarse aggregate can be produced by press processing using a metal pipe or a metal bar, or the like.

### (Modified Aspect of Shape of Coarse Aggregate)

The coarse aggregate of the second mode of the present invention is made of metal, includes a plurality of the spherical portions and the annular portion protruding from the surface of the spherical portions so as to surround the outer periphery of the plurality of spherical portions, and can be formed in various shapes in which the width of the coarse aggregate in the connection portion of the spherical portions on the plane formed by the outer edge of the annular portion is equal to or greater than the minimum diameter of the spherical portions.

For example, in the coarse aggregate 1A shown in FIG. 1Ab, two spherical portions 3 are disposed side by side via the annular portion 5. However, in a coarse aggregate 1C shown in FIG. 5Ab and FIG. 5Bb, two spherical portions 3 are directly connected to each other and each spherical portion 3 has a larger size than a half of the sphere. Thus, the bonding portion of the two spherical portions 3 has a shape of constricted peanut. Such a peanut-shaped coarse aggregate formed by bonding to each other the spherical portions having a larger size than a half of the sphere can also increase tensile strength of the concrete more than the coarse aggregate including a single spherical portion.

The width W of the coarse aggregate 1C in the connection portion P when the spherical portions are directly connected to each other is, as shown in FIG. 5Bb, given by the length W obtained by cutting off, by the outer shape of the coarse aggregate 1C, an extension line La of the chord of the spherical portions formed when two spherical portions 3 are directly connected to each other. In this coarse aggregate 1C, this width W is equal to or greater than the minimum diameter D of the spherical portions 3.

In a coarse aggregate 1D shown in FIG. 6Ab and FIG. 6Bb, three spherical portions 3a, 3b, 3c are directly connected to one another. In this case, the width W of the coarse aggregate in the connection portion of the spherical portions is, as shown in FIG. 6Bb, given by the length W obtained by cutting off, by the outer shape of the coarse aggregate 1D, an extension line La of the chord of the spherical portions formed when three spherical portions are directly connected to one another, and this length W is only required to be equal to or greater than the minimum diameter of the spherical portions in any spherical portion.

In a coarse aggregate 1E shown in FIG. 7b, the spherical portion 3 is positioned at each vertex of the tetrahedron and each spherical portion 3 is surrounded by the annular portion 5. As a production method of this coarse aggregate 1E, four spherical cap portions with flange, in which the spherical cap portion 2 is positioned at each vertex of the triangle and the flange 4 is formed so as to surround these three spherical cap portions 2, are first produced by press molding using a metal plate, and then these flanges 4 are bonded to one another to form a substantially tetrahedral shape.

A coarse aggregate 1F shown in FIG. 8b is produced by bending the corners of the rectangular annular portion 5 upward or downward alternately in the coarse aggregate 1A′ shown in FIG. 3b. Bending the annular portion 5 in this manner can further improve the adhesive force of mortar to the coarse aggregate 1F. Further, the bending of the annular portion 5 can be performed simultaneously with the press processing for pressure-bonding the pair of the spherical cap portions with flange, thereby not resulting in a reduction in productivity of the coarse aggregate 1F.

A coarse aggregate 1G shown in FIG. 9b is produced by making a cut from the vertex of each corner of the rectangular annular portion 5 toward the central direction of the coarse aggregate and bending the cuts upward or downward alternately in the coarse aggregate 1A′ shown in FIG. 3b. Making the cut 5x in the annular portion 5 followed by bending in this manner can also further improve the adhesive force of mortar to the coarse aggregate 1G. Further, making the cut 5x in the annular portion 5 followed by bending can also be performed simultaneously with press processing for pressure-bonding the pair of the spherical cap portions with flange, thereby not resulting in a reduction in productivity of the coarse aggregate 1G.

A coarse aggregate 1H shown in FIG. 10b has the outer shape substantially similar to that of the coarse aggregate 1C shown in FIG. 5Ab and FIG. 5Bb. As shown in FIG. 11b, the spherical portion 3 and the annular portion 5 are simultaneously molded by subjecting the small piece 11 obtained by cutting a metal pipe to a predetermined length to press processing with a die 12. In this case, the diameter of the metal pipe is set to be equal to or greater than the diameter of the spherical portion 3 of the coarse aggregate 1H. According to this coarse aggregate 1H, a step of bonding the flanges 4 to each other can be omitted, and thus productivity of the coarse aggregate can be improved. Note that the outer shape of the annular portion 5 formed by press processing does not always become smooth. However, in the second mode of the present invention, the annular portion 5 does not have to form a perfect annular shape, and a burr may protrude from its shape.

By using the similar method, the coarse aggregate in which three or more spherical portions 3 are directly connected may be molded using a metal pipe, and three or more spherical portions may be disposed side by side via the annular portion 5.

Instead of the small piece 11 obtained by cutting the metal pipe, a solid coarse aggregate having a similar outer shape to that of the coarse aggregate obtained by press molding using a metal pipe can be produced by performing hot press with the similar die using a small piece obtained by cutting a metal bar, or a metal plate. For example, a coarse aggregate 1I shown in FIG. 12b may be produced by hot press with a die 9 as shown in FIG. 13b using a small piece 8 obtained by cutting a metal bar having a plate thickness of equal to or greater than the diameter of the spherical portion. In this case, the diameter of the small piece 8 of the metal bar is set to be equal to or greater than the diameter of the sphere of the spherical portion included in the shape of the coarse aggregate 1I, and the length of the small piece 8 is set to be longer than 2 times the diameter of the spherical portion. The annular portion 5 is formed by pressing the small piece 8. However, this annular portion 5 does not have to form a perfect annular shape, and a burr may protrude from its shape. This coarse aggregate 1I is solidly molded and has a larger specific gravity, and thus it is suitable as the coarse aggregate for heavyweight concrete.

In the coarse aggregate of the second mode of the present invention, in any of the aspects described above, a wire can be protruded from the spherical portion in order to improve bonding strength between the coarse aggregate and the mortar.

A coarse aggregate 1J shown in FIG. 14Ab is produced by pressure-bonding wires 13a between a pair of the flanges 4 in the coarse aggregate 1A shown in FIG. 1Ab. As shown in FIG. 15b, this coarse aggregate 1J is obtained by forming a pair of the spherical cap portions with flange by press-molding in which the flange 4 is continuously formed along the outer periphery of the bottom portions of two spherical cap portions 2, disposing them so as to face each other and placing the wires 13a between the opposing flanges 4 when the flanges 4 are pressed to each other, and pressure-bonding the wires 13a to the flanges 4, so that the wires 13a penetrating the spherical portion 3 are protruded from the annular portion 5. As the wire 13a, a wire of gauge No. 16 or more and No. 21 or less, which has a small diameter and is easily bendable, is preferably used. A thin wire of gauge No. 20 or more is particularly preferably used. When the wires 13a having a small diameter are used, the wires 13a are easily bent by the force applied to the wires 13a at the time of, for example, attaching the wires 13a to the coarse aggregate body including the spherical portion 3 and the annular portion 5 by pressure-bonding the wires 13a to the flanges 4, storing and conveying the coarse aggregate 1J after the attachment, and preparing the fresh concrete including the coarse aggregate 1J. Thus, the wires 13a and the coarse aggregate body are not necessarily strongly fixed to each other by welding or the like, and the wires 13a are only required to be pressure-bonded to the coarse aggregate body to such an extent that the wires 13a do not fall off from the coarse aggregate body. This can reduce time and a cost required for attaching the wires 13a.

Further, when the wire having a small diameter is used, for example, in the stirring step of the fresh concrete after producing the coarse aggregate including the wire, as shown in FIG. 14Bb, the wires 13a are wound around the coarse aggregate body and the mortar is captured by the wound wires 13a, which causes the mortar and the coarse aggregate 1J to move integrally. As a result, the actual specific gravity of the coarse aggregate 1J approaches that of the mortar, and thus, the coarse aggregate 1J is less likely to be sedimented in the fresh concrete and dispersibility is improved.

The coarse aggregate to which the wires 13a are attached may be produced, as shown in FIG. 17b, by passing the wires 13a through the small piece 11 prepared by cutting a metal pipe at a predetermined length and pressing the small piece 11, through which the wires 13a have been passed, with the die 12. This makes it possible to more simply produce a coarse aggregate 1K shown in FIG. 16b having a configuration substantially similar to that of the coarse aggregate 1J shown in FIG. 14Ab.

When the wire is attached to the coarse aggregate body including the spherical portion 3 and the annular portion 5, for example, as seen in a coarse aggregate 1L shown in FIG. 18b, the wires 13a penetrating the spherical portion 3 may protrude from the spherical portion 3. This makes it possible to attach the wire also to the coarse aggregate 1I shown in FIG. 12b including the solid spherical portion 3 and the annular portion 5.

Further, as seen in a coarse aggregate 1M shown in FIG. 19b, the wires 13a may simply be wound from the outside of the coarse aggregate body including the spherical portion 3 and the rectangular annular portion 5. These wires 13a do not penetrate the spherical portion 3 or adhere to the spherical portion 3. When the wires 13a are wound around the coarse aggregate body from the beginning, the mortar tends to adhere to the coarse aggregate 1M as soon as the coarse aggregate 1M is mixed to the mortar, which improves dispersibility of the coarse aggregate 1M in the mortar and strength of the concrete. On the other hand, once the wires 13a are wound around the coarse aggregate body, the wires 13a do not fall off from the coarse aggregate body at the time of storage and conveyance of the coarse aggregate 1M.

### (Surface Processing of Coarse Aggregate)

In any of the coarse aggregates 1A to 1M described above, surface unevenness can be created on the coarse aggregate by emboss processing in order to improve adhesion of mortar in the concrete. Further, molten metal droplets generated by a sputtering phenomenon of various welding types are welded to a part or the whole, preferably the whole, of the surface of these coarse aggregates, so that the surface can be roughened by the metal particles welded to the surface. According to this method, as compared with a case where the surface of the coarse aggregate is roughened simply by irradiating the surface with electron beam or the like, the metal droplets generated by melting the electrode bar adhere to the surface of the coarse aggregate body without reducing the thickness of the coarse aggregate body. Thus, the adhesion of mortar to the coarse aggregate body can be improved without reducing the strength of the coarse aggregate body.

In particular, it is preferable that arc discharge be performed using an electrode preferably with heating, and the molten metal droplets generated from the electrode be welded to the surface of the metal constituting the coarse aggregate under heating. In this manner, as seen in the metal surface shown in FIG. 20b, the entire surface of the coarse aggregate can be roughened by a welded matter of the molten metal droplets. Further, when the arc discharge by which the molten metal droplets are dropped from the electrode is simultaneously performed to a plurality of the coarse aggregates, the coarse aggregates are sometimes bonded to each other by the molten metal droplets. For example, FIG. 21b shows a coarse aggregate 1N which is produced as follows. First, the coarse aggregate including two spherical portions 3 is produced by press molding using a metal pipe in the same manner as in the FIG. 1Ab, and, next, a plurality of the coarse aggregates thus produced are simultaneously subjected to the arc discharge using the electrode bar, so that two of the coarse aggregates each including two spherical portions are combined and bonded to each other by welding to produce the coarse aggregate 1N. The entire surface of the coarse aggregate 1N is roughened by the welded matter of the molten metal droplets and the coarse aggregate 1N has the shape in which two coarse aggregates are bonded by welding. Thus, as compared with the similar coarse aggregates in which the welded matter of the molten metal droplets is attached to the surface without causing the bonding of the coarse aggregates, tensile strength of the concrete can be further improved. Thus, the second mode of the present invention provides a coupling body of the coarse aggregate for concrete in which the metallic coarse aggregates each including the spherical portion and the annular portion protruding from the surface of the spherical portion so as to surround the outer periphery of the spherical portion are welded to each other and of which the entire surface has the molten metal droplets attached to it.

Note that welding of the molten metal droplets melted from the electrode bar to the surface of the coarse aggregate by the arc discharge can be performed with high productivity and at a low cost.

Further, instead of performing welding of the molten metal droplets to the coarse aggregate by the arc discharge as described above, welding of the molten metal droplets may be performed by applying the arc discharge or the like in advance to a metal plate, a metal pipe, or a metal bar to be used at the time of producing the coarse aggregate.

### (Application Example of Coarse Aggregate)

The coarse aggregate for concrete of the second mode of the present invention can partially or wholly replace the coarse aggregate in the blending composition of the conventional concrete. As a preferable application example of the coarse aggregate for concrete of the second mode of the present invention, as a concrete precast product, for example, the hollow coarse aggregate of the present invention can be used to produce a light-weight ferroconcrete plate that is highly resistant to compression and tension. Further, it can be preferably applied to a concrete structure not including a reinforcing bar (e.g., a dam wall, a road directly laid on the ground surface, a mat foundation for a construction, and a paved square). As a specialized application example, it can be preferably applied to a ferroconcrete floor slab for a highway constructed at a position away from the ground surface, or the like. When the coarse aggregate for concrete of the present invention is formed from iron, in particular, when it is made solid, it can be useful as the coarse aggregate for heavyweight concrete used for shielding radiation in a nuclear facility or the like. Further, when the coarse aggregate for concrete of the second mode of the present invention is constituted from a magnetic material, conveyance, installation, and removal of a panel can be performed through attraction to an electromagnet, and thus workability is improved.

### (Third Mode of the Present Invention)

Hereinafter, a coarse aggregate for concrete of the third mode of the present invention will be described in detail with reference to drawings. Note that, in the present mode, the same reference numerals represent the same or similar constituent elements in each drawing.

### (Shape of Coarse Aggregate)

FIG. 1Ac is a perspective view of a coarse aggregate 1A for concrete of an example of the third mode of the present invention and FIG. 1Bc is a cross-sectional view thereof. This coarse aggregate 1A is made of metal and includes a spherical cap portion bonded body 3 including two hollow spherical cap portions 2. The term □spherical cap□ described herein is a shape obtained by dividing a sphere with a cut plane, and the term □spherical cap portion□ refers to a portion of the coarse aggregate having such a shape.

In the present example, each spherical cap portion 2 preferably has a shape of spherical cap equal to or greater than a half of the sphere. In the coarse aggregate 1A of the present example, two opposing spherical cap portions 2 have a shape of hemisphere and the radius r of a sphere of each spherical cap portion 2 is equal to the height h of the spherical cap portion 2. Further, the two spherical cap portions 2 are bonded symmetrically to each other across a bottom surface 2g of each spherical cap portion 2. Accordingly, the outer shape of this spherical cap portion bonded body 3 forms a spherical shape and the outer shape of the coarse aggregate as a whole also forms a substantially spherical shape. Thus, as compared with the coarse aggregate of which the outer shape is a polyhedral shape or an indeterminate three-dimensional shape, the coarse aggregate exhibits high strength to a plane load or a splitting tensile load applied from any direction. Note that, in FIG. 1Bc, a reference sign O1 denotes the center of the sphere and a reference sign O2 denotes the center of the bottom surface 2g of the spherical cap portion 2. In the coarse aggregate 1A of the present example, their positions are overlapped with each other.

In the coarse aggregate 1A, an annular portion 5 protruding from the surface of the spherical cap portion bonded body 3 so as to surround the bottom portion of the spherical cap portion 2 is formed, and thus the coarse aggregate body 1A□ is constituted by the spherical cap portion bonded body 3 and the annular portion 5. This annular portion 5 is formed by bonding the annular flanges 4 formed around the outer peripheries of the bottom surfaces 2g of the respective spherical cap portions. The annular portion 5 is formed over the entire periphery of the spherical cap portion bonded body 3, and thus the coarse aggregate 1A has an approximate Saturn shape. The annular portion 5 increases the adhesive force between the coarse aggregate 1A and the mortar when the coarse aggregate 1A is mixed with the mortar. Thus, along with the above-described strength improvement effect caused by the outer shape being a substantially spherical shape, the concrete prepared by using this coarse aggregate 1A instead of the conventional coarse aggregate has significant improvements in compressive strength and tensile strength.

Note that the coarse aggregate 1A of the present example includes the annular portion 5 having an annular shape. However, in the third mode of the present invention, the outer shape of the annular portion 5 in plan view is not limited to the circle, and it may be an oval shape, an irregular annular outer shape, or a rectangle. As a coarse aggregate 1B shown in FIG. 3c, the coarse aggregate including the annular portion 5 having a rectangular shape is obtained by molding the spherical cap portion 2 by press processing using a rectangular metal plate and bonding the flanges 4 of the spherical cap portions with the rectangular flanges 4 thus obtained to each other by press processing. When the sides forming the rectangular flange 4 are curved by press processing of the spherical cap portion 2, the curved shape may be maintained. It is preferable to make the annular portion 5 rectangular because any punching slag can be reduced. The edge of the annular portion 5 may have a burr. The surface of the annular portion 5 may have irregularities.

A plurality of flexible wires 13a penetrate the spherical cap portion bonded body 3, so that the plurality of wires 13a protrude from the coarse aggregate body 1A′, more specifically from the ends of the annular portion 5. It is preferable that the length L2 of the protrusion portion of the wire 13a be 1 to 5 times, specifically 1 to 3 times the maximum diameter L3 of the spherical cap portion bonded body 3. Here, the length of the protrusion portion of the wire 13a is the length when the wire which was bent is extended in a substantially straight line shape. When one coarse aggregate for concrete has a plurality of spherical cap portion bonded bodies as described below, the maximum diameter of the spherical cap portion bonded body 3 means the maximum diameter among them.

Since the length L2 of the protrusion portion of the wire 13a is not less than 1 time the maximum diameter L3 of the spherical cap portion bonded body 3, the wires 13a are wound around the coarse aggregate body as shown in FIG. 1Cc, so that they cover the entire surface of the coarse aggregate body and make it easier for the mortar to be captured by the coarse aggregate as described below. On the other hand, by setting the length L2 of the protrusion portion of the wire 13a to 5 times or less, preferably 3 times or less, the maximum diameter L3 of the spherical cap portion bonded body 3, it is possible to prevent the wires 13a of the coarse aggregate for concrete from being entangled with each other unnecessarily and prevent the coarse aggregate for concrete from not being uniformly dispersed in the fresh concrete.

The number of wires 13a protruding from one end of the coarse aggregate body 1A′ is preferably 2 to 5.

It is not always necessary that all of the plurality of wires protruding from the coarse aggregate body have a diameter of 1 to 5 times the maximum diameter L3 of the spherical cap portion bonded body 3, and there may be a protrusion portion having a length outside this range. However, it is preferable that the protrusion portions of all the wires have such a length. Here, □the length of the protrusion portion of the wire□ can be defined as □when a part of the wire protruding outside the coarse aggregate body is bent, whether one end of the protrusion portion is held by the coarse aggregate body or both ends of the protrusion portion are held by the coarse aggregate body with the protrusion portion forming a loop, the length of the part of the wire protruding outside the coarse aggregate body when it is extended to a straight line in a state in which the end held by the coarse aggregate body remains held.□

As the wire 13a, a wire of gauge No. 16 or more and 21 or less, which has a small diameter and is easily bendable, is preferable, and a wire of gauge No. 20 or more is particularly preferable. When a wire having a small diameter and being easily bendable is used, the wires 13a are easily bent by applying a force to the wires 13a even at the time of attaching the wires 13a to the coarse aggregate body 1A′ including the spherical cap portion bonded body 3 and the annular portion 5, storing and conveying the coarse aggregate after the attachment, and preparing the fresh concrete including the coarse aggregate 1A. Thus, the wires 13a and the coarse aggregate body are not necessarily strongly fixed to each other by welding or the like, and the wires 13a are only required to be pressure-bonded to the coarse aggregate body to such an extent that the wires 13a do not fall off from the coarse aggregate body. This can reduce time and a cost required for attaching the wires 13a.

Further, when the wires having a small diameter and being easily bendable are used, for example, in the stirring step of the fresh concrete, as shown in FIG. 1Cc, the wires 13a are wound around the coarse aggregate body 1A′ to cover the entire coarse aggregate body and the mortar is captured by the wound wires 13a, which causes the mortar and the coarse aggregate 1A to move integrally. As a result, the actual specific gravity of the coarse aggregate 1A approaches that of the mortar, and thus, the coarse aggregate 1A is less likely to be sedimented in the fresh concrete and dispersibility is improved.

On the other hand, a wire having a diameter larger than gauge No. 16, and preferably a wire having a large diameter of gauge No. 8 or more and gauge No. 12 or less may be used together with the wire having a small diameter. In this case, it is preferable that the tip end of the wire having a large diameter be bent into a key shape, a C shape or the like. The large-diameter wire does not wind around the coarse aggregate body 1A′ as shown in FIG. 1Cc even after the stirring process of the fresh concrete, but since the tip end of the large-diameter wire is curved, the wire exhibits an anchor effect in the concrete and can increase the tensile strength of concrete.

### (Size of Coarse Aggregate)

In order to allow the fresh concrete in which the coarse aggregate 1A is blended to be pumped through a hose by pressure feeding, when the radius of the sphere of the spherical cap portion 2 is represented by r and the protrusion length of the annular portion 5 is represented by L, the maximum diameter ((r+L)×2) of the spherical cap portion bonded body 3 is preferably set to be approximately the same size as that of crushed gravel or stones of the conventional coarse aggregate. Specifically, the maximum diameter ((r+L)×2) of the coarse aggregate 1A is preferably set to be within a range of particle size and particle shape defined by JIS A 5308. In general, it is preferable that the diameter 2r of the sphere of the spherical cap portion 2 be set to be 10 mm to 30 mm, and the protrusion length L of the annular portion 5 be set to be ⅖ to 1 time the radius r of the sphere of the spherical cap portion 2. On the other hand, if the protrusion length L of the annular portion 5 is too small, when the annular portion 5 is formed by bonding to each other the flanges 4 formed outside the bottom portion of the spherical cap portion 2, it is difficult to strongly bond the flanges to each other. Further, when formation of the spherical cap portion bonded body by pressure-bonding of the spherical cap portions and insertion of the wire are not performed at the same time in the production method of the coarse aggregate, the spherical cap portion bonded body 3 is caused to excessively easily roll and thus handleability is deteriorated.

In the third mode of the present invention, the outer shape of the spherical cap portion bonded body 3 is a shape of sphere or a shape similar to sphere, and thus the height h of the spherical cap portion 2 is preferably equal to or greater than the radius r of the sphere of the spherical cap portion 2. In the coarse aggregate 1A of the present example, the height h of the spherical cap portion 2 is equal to the radius r of the sphere of the spherical cap portion 2. On the other hand, if the height h is too large, the maximum length of the spherical cap portion bonded body 3 becomes long, which may hinder pumping of concrete through a hose by pressure feeding. Therefore, the height h of the spherical cap portion 2 is preferably 1.8 times or less the radius r of the sphere of the spherical cap portion 2.

### (Thickness of Spherical Cap Portion)

The thickness t of the spherical cap portion 2 can be determined in accordance with, for example, the kind of metal constituting the coarse aggregate 1A, the formation method of the shape of the spherical cap portion, and the use of the concrete prepared by using the coarse aggregate. For example, when the coarse aggregate is used in heavyweight concrete for radiation shield, the specific gravity of the coarse aggregate is preferably increased by increasing the thickness t of the spherical cap portion 2. There is no particular upper limitation on the thickness t. In this case, the spherical cap portion 2 can be produced by hot press.

On the other hand, when the coarse aggregate is used for the normal concrete and the spherical cap portion is formed by cold press, the spherical cap portion 2 having an excessively large thickness t makes it difficult to form the spherical cap portion by press processing, while the spherical cap portion 2 having an excessively small thickness t causes insufficient strength even when the coarse aggregate is used for the normal concrete. Thus, the thickness t of the spherical cap portion 2 is preferably set to be 1 mm to 6 mm.

### (Constituent Metal of Coarse Aggregate)

As the metal constituting the coarse aggregate 1A of the third mode of the present invention, iron, aluminum, titanium, copper, stainless steel, and the like can be mentioned, and the metal can be selected in accordance with the use of the concrete. For example, when the coarse aggregate is included in the heavyweight concrete used for shielding radiation in a nuclear facility or the like, the metal with high density such as iron is preferably used from the viewpoint of shielding X rays, γ rays, and the like. In order to perform production, conveyance, and the like of the coarse aggregate 1A itself or various concrete products including the coarse aggregate 1A by using an electromagnet, the coarse aggregate is preferably formed from a magnetic substance such as iron.

### (Production Method of Coarse Aggregate)

As a production method of the coarse aggregate 1A, first, the spherical cap portion 2 having the flange 4 at its bottom portion is formed by press processing using a metal plate. Next, as shown in FIG. 2c, a pair of the spherical cap portions 2 with flange 4 are disposed so as to face each other while the wires 13a are sandwiched between the opposing flanges 4, and the opposing flanges 4 are pressure-bonded to each other by press processing, followed by welding them and pressure-bonding the wires 13a to the flanges 4. The coarse aggregate 1A can be easily produced in this manner. Welding of the flanges 4 is preferably performed over the entire periphery thereof. On the other hand, the flanges 4 may be bonded to each other by caulking instead of welding the flanges 4 to each other.

### (Modified Aspect of Shape of Coarse Aggregate)

The coarse aggregate of the third mode of the present invention is made of metal and can take various shapes as long as it includes the spherical cap portion bonded body having two spherical cap portions, the annular portion formed around the outer periphery of the spherical cap portion bonded body, and the plurality of flexible wires penetrating the spherical cap portion bonded body and protruding from the spherical cap portion bonded body or the annular portion. For example, as shown in FIG. 2c, when a plurality of small-diameter wires 13a are sandwiched between a pair of spherical cap portions 2 with flange, the wires 13a may be sandwiched between a plurality of pairs of spherical cap portions with flange and pressed. By this method, like a coarse aggregate 1C shown in FIG. 4c, the wires 13a can be made to protrude by making the annular portions of the spherical cap portion bonded body 3 each having the annular portion 5 adjacent to each other, or the coarse aggregate may take the form in which the spherical cap portion bonded bodies 3 each having the annular portion 5 are spaced apart from each other and are connected to each other by the wires 13a protruding from the annular portions 5 thereof like a coarse aggregate 1D as shown in FIG. 5c.

When the wire is to be protruded in the coarse aggregate, the wires 13a penetrating the spherical cap portion bonded body 3 may be protruded from the surface of the spherical cap portion bonded body 3 like a coarse aggregate 1E as shown in FIG. 6Ac. The coarse aggregate 1E can be produced by forming a through-hole in the spherical cap portion bonded body 3 and inserting the wires 13a into the through-hole. A plurality of wires 13a may be passed through one through-hole, or a plurality of through-holes may be opened and one wire 13a may be passed through one through-hole. In this coarse aggregate 1E, as shown in FIG. 6Bc, the wires 13a are wound around the coarse aggregate body to entirely cover the coarse aggregate body in the stirring step of the fresh concrete or the like, and the mortar is captured by the wound wires 13a, so that the mortar and the coarse aggregate 1E move integrally. As a result, the coarse aggregate is less likely to be sedimented in the fresh concrete and dispersibility of the coarse aggregate is improved.

Even when the wire is protruded from the surface of the spherical cap portion bonded body 3, the spherical cap portion bonded bodies 3 having a plurality of annular portions 5 may be adjacent to each other like a coarse aggregate 1F shown in FIG. 7Ac. Also in the coarse aggregate 1F, as shown in FIG. 7Bc, the wires 13a are wound around the coarse aggregate body in the stirring step of the fresh concrete or the like, and the wires covers the coarse aggregate body as a whole.

In addition, as shown in FIG. 8c, a coarse aggregate 1G is formed by joining the spherical cap portion bonded bodies 3 of the coarse aggregate bodies in which the wires 13a penetrate the spherical cap portion bonded bodies 3 and protrude from the annular portions 5. As shown in FIG. 9Ac, such a coarse aggregate 1G shown in FIG. 8c is obtained by first bonding the tops of the pair of spherical cap portions 2 with flange 4 by spot welding or the like, then causing other spherical cap portions 2 with flange 4 to be opposed to the joined spherical cap portions 2 with flange 4 so as to oppose the flanges 4 to each other via the wires 13a, as shown in FIG. 9Bc, and bonding the opposed flanges 4 by pressing.

A coarse aggregate 1H shown in FIG. 10c has wires 13a penetrating the spherical cap portion bonded body 3 and protruding from the spherical cap portion bonded body 3, which is common feature to the coarse aggregate 1E shown in FIG. 6Ac. A sheet-shaped metallic mesh material 14 is sandwiched between the flanges 4 forming the annular portion 5. As the metallic mesh material 14, a woven net such as a plain weave and a twill weave, a lath net, a welding net, a perforated metal, or the like can be used. Generally, the mesh spacing or opening diameter of the metallic mesh material 14 is preferably 4 mm to 10 mm. The metallic mesh material 14 incorporated into the coarse aggregate 1H causes mortar to easily adhere to the metallic mesh material 14, so that the coarse aggregate 1H is less likely to be sedimented in the mortar and dispersibility is improved.

A coarse aggregate body 1I′ of a coarse aggregate 1I shown in FIG. 11c has a rectangular annular portion 5 as in the coarse aggregate body 1B shown in FIG. 3c, but is different therefrom in that there are no flange bonded marks over the entire peripheral portion of the annular portion 5. As shown in FIG. 11c, this coarse aggregate 1I can be produced by passing wires 13a through a small piece 11 obtained by cutting a metal pipe into a predetermined length and pressing the small piece 11 with the passing wires 13a with a die 12. Therefore, the step of bonding the spherical cap portions with the flanges in the production process of the coarse aggregate body can be eliminated. Therefore, this coarse aggregate 1I can be produced more easily than the coarse aggregate 1B shown in FIG. 3c. The annular portion 5 formed by pressing the small piece 11 of the metal pipe does not need to be a clean annular shape, and may have a shape in which a burr is projected.

In producing the coarse aggregate using the metal pipe, as shown in FIG. 12c, the small piece 11 obtained by cutting the metal pipe is pressed, so that a coarse aggregate body 1J′ including the spherical cap portion bonded body 3 and the annular portion 5 can be formed. This has a significance as a method for producing the coarse aggregate body itself. Further, a through-hole may be formed in the spherical cap portion bonded body 3 of the obtained coarse aggregate body 1J′, and the wires 13a may be passed through the through-hole to obtain a coarse aggregate 1J.

In addition, a method for producing a coarse aggregate body including a spherical cap portion bonded body and an annular portion by pressing a metal pipe as shown in FIG. 11c and FIG. 12c has high productivity as compared with a method for producing by pressing a metal plate to produce a spherical cap portion with flange and then pressure-bonding the spherical cap portions with flange. Furthermore, this coarse aggregate body can also be used as the coarse aggregate. Therefore, the third mode of the present invention also encompasses a method for producing a coarse aggregate for concrete including a spherical cap portion bonded body and an annular portion protruding from the surface of the spherical cap portion bonded body so as to surround the entire outer periphery of the spherical cap portion bonded body. In such a production method, the spherical cap portion bonded body and the annular portion surrounding the entire outer periphery of the spherical cap portion bonded body are formed by press processing using a metal pipe.

On the other hand, in a coarse aggregate 1K shown in FIG. 13c, wires 13a to be pressed by the pair of flanges 4 in the coarse aggregate 1A shown in FIG. 1Ac are preliminarily formed into a loop shape. In this case, the loop-shaped wires 13a protruding from the annular portion 5 preferably have a length L2 that is 1 to 5 times the maximum diameter of the spherical cap portion bonded body, where the length L2 is defined in a state where the loop is extended as shown by the two-dot chain line in the figure.

A coarse aggregate 1L shown in FIG. 14c has a spherical cap portion bonded body 3 having two hollow spherical cap portions and an annular portion 5 protruding from the surface of the spherical cap portion bonded body 3 so as to surround the outer periphery of the spherical cap portion bonded body 3, which is the common feature to the coarse aggregate 1A shown in FIG. 1Ac. However, in the coarse aggregate 1L, the wires 13a do not penetrate a coarse aggregate body 1L′, but the wires 13a not bonded to coarse aggregate body 1L′ are wound around the outer surface of the coarse aggregate body 1L′ in multiple layers. When the wires 13a are wound around the coarse aggregate body 1L′ in this manner, mortar easily adheres to the coarse aggregate 1L from the beginning when the coarse aggregate 1L is mixed with the mortar, and dispersibility of the coarse aggregate 1L in the fresh concrete is improved, and the strength of concrete is improved.

In particular, in this coarse aggregate 1L, the shape of the annular portion 5 in plan view is rectangular, and each side of the rectangle is preferably recessed inward under the influence of the press of the spherical cap portion. The deviation of the wires 13a is prevented when the wires 13a are wound around the coarse aggregate body 1L′, so that the wires 13a can be easily wound. Thus, when the wires 13a are wound around the coarse aggregate body 1L′ in this manner, it is not necessary for the wires 13a to be sandwiched between the flanges 4 constituting the annular portion 5, to pass a through-hole that is opened in the coarse aggregate body 1L′, or to be bonded to the coarse aggregate body 1L′. Accordingly, the coarse aggregate can be easily produced.

The gauge number of the wire to be wound around the coarse aggregate body 1L′ is preferably gauge No. 8 to gauge No. 20, and more preferably gauge No. 12 to gauge No. 20.

In a coarse aggregate 1M shown in FIG. 15c, a coarse aggregate body 1M′ has a spherical cap portion bonded body 3 having two hollow spherical cap portions and an annular portion 5 protruding from the surface of the spherical cap portion bonded body 3 so as to surround the outer periphery of the spherical cap portion bonded body 3, which is the common feature to the coarse aggregate 1A shown in FIG. 1Ac. However, the coarse aggregate 1M has an outer fitting portion 15 which is formed from bent wires and fitted on the annular portion 5. The outer fitting portion 15 can be produced by winding wires, which have been bent in a rectangular corrugated shape, in a circular shape to form an annular shape. Since the outer fitting portion 15 has a spring property, it can be easily fitted on the annular portion 5 of the coarse aggregate body 1M′.

The third mode of the present invention can take various aspects even for the coarse aggregate body. In a coarse aggregate 1N shown in FIG. 16c, the corners of the rectangular annular portion 5 of the coarse aggregate 1B shown in FIG. 3c are alternately bent upward or downward. The annular portion 5 bent in this manner can further improve the adhesive force of the mortar to the coarse aggregate 1N. Further, the bending of the annular portion 5 can be performed simultaneously with the press of a pair of flanges 4 to form the annular portion 5, thereby not resulting in a reduction in productivity of the coarse aggregate.

In a coarse aggregate 1O shown in FIG. 17c, a cut 5x is made from the vertex of each corner of the rectangular annular portion 5 of the coarse aggregate 1B shown in FIG. 3C toward the center of the coarse aggregate 1B, and both sides thereof are bent upward or downward. Cutting and bending the annular portion 5 in this manner can also further improve the adhesive force of the mortar to the coarse aggregate 1O. Further, such cutting and bending of the annular portion 5 can be performed simultaneously with the formation of the annular portion 5 by pressing the pair of flanges 4, thereby not resulting in a reduction in productivity of the coarse aggregate.

In a coarse aggregate 1P shown in FIG. 18c, hemispherical recessed portions are formed on the top portions of the spherical cap portion bonded body 3 produced by pressing spherical press heads on both top portions of the spherical cap portion bonded body 3 in the coarse aggregate 1B shown in FIG. 3c. Formation of the recessed portions 3a on the top portions of the spherical cap portion bonded body 3 in this manner can further improve the adhesive force of the mortar to the coarse aggregate 1P. Further, such press processing performed on the top portions of the spherical cap portion bonded body 3 can be performed simultaneously with the press processing of the pair of flanges 4, thereby not resulting in a reduction in productivity of the coarse aggregate.

Note that the depth d of the recessed portion 3a is preferably set to be ⅓ to ½ times the radius r of the spherical cap portion bonded body 3.

A coarse aggregate body 1Q′ shown in FIG. 19c is formed by molding the annular portion 5 into a radial folded plate shape. Accordingly, the flange 4a of one spherical cap portion 2a and the flange 4b of the other spherical cap portion 2b can be overlapped with each other without displacement, and the flanges 4a and 4b can be easily and firmly pressure-bonded, so that the strength of the annular portion 5 increases. The adhesion of the coarse aggregate body to mortar in the concrete is also improved.

In a coarse aggregate body 1R′ shown in FIG. 20Ac and FIG. 20Bc, the spherical cap portions 2 with flange 4 used in the production of the coarse aggregate 1A shown in FIG. 1Ac are bonded with a metal plate 6 interposed therebetween. In this manner, the strength of the annular portion 5 can be increased.

In a coarse aggregate body 1S′ shown in FIG. 21Ac and FIG. 21Bc, one spherical cap portion 2a of the pair of spherical cap portions used in the production of the coarse aggregate is provided with a flange 4 thereon, but the other spherical cap portion 2b is provided with no flange while the other spherical cap portion 2b is fitted into the one spherical cap portion 2a.

In a coarse aggregate body 1T′ shown in FIG. 22c, the height h of each of the spherical cap portions 2 forming the spherical cap portion bonded body 3 is set to be 1.1 to 1.8 times the radius r of the sphere of the spherical cap portion 2 in the coarse aggregate body of the coarse aggregate 1A shown in FIG. 1Ac. As a result, the shape of each of the spherical cap portions 2 becomes a spherical cap shape having a larger size than a half of the sphere, and the bonding portion thereof has a shape of constricted peanut. Further, an annular portion 5 in which the two flanges 4 are bonded is formed in the constricted portion. In this manner, the peanut-shaped coarse aggregate body 1T′ in which the spherical cap portions including the spherical caps having a larger size than a half of the sphere are bonded together can increase a tensile strength of concrete more than the coarse aggregate body of the coarse aggregate 1A shown in FIG. 1Ac.

In a coarse aggregate body 1U′ shown in FIG. 23c, a cylindrical portion 10 having the same diameter as that of the bottom surface 2h is extended from the bottom surface 2h of the spherical cap of the coarse aggregate 1A shown in FIG. 1Ac to serve as a spherical cap portion 2, a flange 4 is formed around the bottom surface 2g of the spherical cap portion 2, and the two flanges 4 are bonded together. As described above, in the coarse aggregate of the third mode of the present invention, the spherical cap portion 2 does not have to be strictly composed only of the spherical cap portions.

In a coarse aggregate body 1V′ shown in FIG. 24c, one spherical cap portion 2a of the two spherical cap portions 2 bonded at their flanges 4 has a larger radius than that of the other spherical cap portion 2b. As a result, the two spherical cap portions 2a and 2b sandwiching the bonding surface of the flanges 4 are asymmetrical, and the shape of the spherical cap portion bonded body 3 in which the two spherical cap portions 2a and 2b are bonded is substantially oval.

As described above, the coarse aggregate bodies shown in FIG. 16c to FIG. 24c can be provided with a wire penetrating the spherical cap portion bonded body and protruding from the spherical cap portion bonded body or a wire penetrating the spherical cap portion bonded body and protruding from the annular portion.

### (Surface Processing of Coarse Aggregate Body)

In the third mode of the present invention, in order to improve the adhesion of mortar, molten metal droplets generated by a sputtering phenomenon of various welding types are welded to a part or the whole, preferably the whole, of the surface of the coarse aggregate body, so that the surface can be roughened by the metal particles welded to the surface. According to this method, as compared with a case where the surface of the coarse aggregate is roughened simply by irradiating the surface with electron beam or the like, the metal droplets generated by melting an electrode bar are adhered to the surface of the coarse aggregate body without reducing the thickness of the coarse aggregate body, and thus the adhesion of mortar to the coarse aggregate body can be improved without reducing the strength of the coarse aggregate body.

In particular, it is preferable that arc discharge be performed using an electrode preferably with heating, and the molten metal droplets generated from the electrode be welded to the surface of the coarse aggregate body under heating. In this manner, as seen in the metal surface shown in FIG. 25c, the entire surface of the coarse aggregate body can be roughened by a welded substance of the molten metal droplets. Note that welding of the molten metal droplets using arc discharge to the surface of the coarse aggregate body can be performed with high productivity and at a low cost.

Further, instead of welding of the molten metal droplets of the electrode bar to the coarse aggregate body by arc discharge as described above, welding of the molten metal droplets of the electrode bar may be performed by applying arc discharge or the like in advance to a metal plate, a metal pipe, or a metal bar to be used at the time of producing the coarse aggregate.

Note that the modified aspects of the third mode of the present invention described above can be appropriately combined with one another.

### (Application Example of Coarse Aggregate)

The coarse aggregate for concrete of the third mode of the present invention can partially or wholly replace the coarse aggregate in the blending composition of the conventional concrete. As a preferable application example of the coarse aggregate for concrete of the third mode of the present invention, as a concrete precast product, for example, the hollow coarse aggregate of the third mode of the present invention can be used to produce a light-weight ferroconcrete plate that is highly resistant to compression and tension. The coarse aggregate for concrete can be preferably used for a concrete construction without a reinforcing bar (e.g., a dam wall, a road set directly on the ground, a mat foundation for a construction, and a paved place). As a specialized application example, the coarse aggregate for concrete can be preferably used for a ferroconcrete floor slab for an express-highway set at a position apart from the ground, or the like. Further, when the coarse aggregate for concrete of the present invention is constituted from a magnetic material, conveyance, installation, and removal of a panel can be performed through attraction to an electromagnet, and thus workability is improved.

### (Fourth Mode of the Present Invention)

Hereinafter, a coarse aggregate for concrete of the fourth mode of the present invention will be described in detail with reference to drawings. Note that, in the present mode, the same reference numerals represent the same or similar constituent elements in each drawing.

### (Entire Shape)

FIG. 1d is a perspective view of a coarse aggregate 1A for concrete of one example of the fourth mode of the present invention. The coarse aggregate 1A is formed of a hollow metallic mesh material M. More specifically, the coarse aggregate 1A for concrete has a protruded portion 2 having a hollow interior and a substantially spherical outer shape at the center thereof, and an annular flange 3 around the entire periphery of the protruded portion 2, all of which are formed of the metallic mesh material M. Providing the flange 3 facilitates the bonding of hemispheres with flange when the coarse aggregate 1A is produced by combining two hemispheres with flange as described below. The flange 3 reduces the tendency of rolling of the coarse aggregate 1A, thereby improving handleability thereof.

As to the size of the coarse aggregate for concrete in the fourth mode of the present invention, in order to allow the fresh concrete in which the coarse aggregate 1A is blended to be pumped through a hose by pressure feeding, the maximum diameter of the coarse aggregate for concrete is preferably set to be approximately the same size as that of gravel or crushed stones of the conventional coarse aggregate. Specifically, the maximum diameter of the coarse aggregate 1A including the protruded portions 2 and the flange 3 is preferably set to be within a range of particle size and particle shape defined by JIS A 5005 and JIS A 5308.

### (Metallic Mesh Material)

As the metallic mesh material in the fourth mode of the present invention, a woven net such as a plain weave and a twill weave, a lath net, a welding net, a perforated metal, a ring mesh, or the like can be used. The outer shape of the predetermined coarse aggregate may be formed by molding a flat metallic mesh material, or the metallic mesh material that forms the outer shape of the predetermined coarse aggregate may be formed by bonding individual annular materials together.

The coarse aggregate 1A for concrete according to the present example uses a woven net. The woven net used allows the mortar to be more likely to enter the holes of the mesh as compared with the case where perforated metal having the same aperture ratio is used, and the adhesive force of the mortar to the metallic mesh material can be further improved. On the other hand, the perforated metal used facilitates the press molding of a metallic mesh material and welding of metallic mesh materials together.

Even when any kind of metallic mesh material is used, it is preferable that the mesh spacing or opening diameter be usually 4 mm to 10 mm from the viewpoint of causing the mortar to easily enter the inside of the coarse aggregate 1A for concrete so that the mortar is contained in the metallic mesh material and integrated thereto when the coarse aggregate 1A for concrete is mixed with the mortar. On the other hand, the weight of the concrete may be reduced by not allowing the mortar to completely enter the inside of the coarse aggregate and forming a cavity inside the coarse aggregate. In this case, the opening diameter of the mesh may be selected so that when the coarse aggregate 1A for concrete is mixed with the mortar, the opening of the mesh becomes the resistance for the mortar entering the inside of the coarse aggregate.

In the fourth mode of the present invention, the wire diameter of the wire forming the metallic mesh material is determined according to the type of metal forming the wire from the viewpoint that it can be easily formed into a predetermined shape. For example, in the case of an iron wire used, the wire diameter is preferably 0.8 mm to 6 mm, more preferably 1 mm to 3 mm. It should be noted that a mesh material using a wire having a large wire diameter cannot be configured as a woven net, but is formed as a welded net.

Further, in the fourth mode of the present invention, a core material can be put inside the coarse aggregate as described below. When the core material is not put inside the coarse aggregate 1A and only the metallic mesh material is used as the constituent material of the coarse aggregate 1A as in this example, it is preferable to use a wire that is hard and thick as compared with the case where the core material is put inside the coarse aggregate 1A in order to substantially maintain the shape of the coarse aggregate 1A and prevent the coarse aggregate 1A from floating even when the coarse aggregate 1A is stirred in fresh concrete.

### (Constituent Metal of Metallic Mesh Material)

Examples of the types of metal constituting the metallic mesh material may include iron, aluminum, titanium, copper, and stainless steel, which can be selected according to the use of concrete. For example, from the viewpoint of making it possible to use a magnet during the production or conveyance of various concrete products including the coarse aggregate 1A for concrete, it is preferable that the constituent metal of the metallic mesh material be a magnetic material such as iron.

### (Production Method of Coarse Aggregate 1A for Concrete)

As a production method of the coarse aggregate 1A for concrete shown in FIG. 1d, for example, as shown in FIG. 2d, a pair of articles including a hemispherical protruded portion 4 and a flange 5 around the opening thereof is molded by press processing of a flat metallic mesh material, and the flanges 5 are overlapped with each other and bonded together. The bonding method of the flanges 5 to each other may include stitching with a wire, fixing with a stapler, welding, caulking of the peripheral portion of the flanges 5 as shown in FIG. 3d.

### (Core Material)

The coarse aggregate for concrete of the fourth mode of the present invention may have a core material thereinside. For example, a coarse aggregate 1B for concrete shown in FIG. 4Ad and FIG. 4Bd is formed of the same metallic mesh material as that of the coarse aggregate 1A for concrete shown in FIG. 1d, and the core material 6 is disposed inside the protruded portion 2. When the core material 6 is disposed inside the protruded portion 2, the specific gravity of the coarse aggregate 1B for concrete as a whole can be adjusted by appropriately selecting the material of the core material 6, so that the coarse aggregate 1B formed of a metallic mesh material can be prevented from floating in fresh concrete and the dispersibility is improved. Further, appropriate selection of the material of the core material 6 can also improve the compressive strength of the concrete after hardening. In the case of reducing the weight of concrete, for example, glass, foamed glass, wood, resin, foamed resin such as polystyrene foam, or the like can be used as the core material 6. There is no particular limitation on these shapes. On the other hand, in order to prevent the coarse aggregate 1B from floating in the fresh concrete and to increase the compressive strength of the concrete, metal materials such as an iron piece and an iron ball, crushed stone, gravel, concrete, or the like can be used. Also in this case, the shape of the core material 6 is not particularly limited, but it is preferable that the surface thereof be not smooth from the viewpoint of improving the adhesion between the core material 6 and the mortar. Therefore, when the core material 6 is formed of a metal material, it is preferable that the core material 6 be subjected to surface roughening by molten metal droplets adhered thereto by use of arc discharge or the like and use of a chemical or the like.

Further, it is preferable to use a magnetic material such as an iron material because a magnet can be used in the step of conveying the coarse aggregate and the concrete product using such a coarse aggregate.

### (Modified Aspect)

The coarse aggregate for concrete of the fourth mode of the present invention can include various aspects. For example, a coarse aggregate 1C for concrete shown in FIG. 5Ad and FIG. 5Bd is one obtained by using perforated metal as a metallic mesh material and molding the protruded portion 2 having a substantially spherical shape and the ring-shaped flange 3 in the same manner as that for the coarse aggregate 1A for concrete shown in FIG. 1d. This coarse aggregate 1C for concrete can also be produced by subjecting plate-like perforated metal to press processing to mold a pair of articles in which a flange is disposed around the opening portion of the protruded portion having a substantially hemispherical shape, overlapping these flanges with each other, and bonding these flanges to each other by any method. When the perforated metal is used, the form and the disposition of the holes are not limited, and, for example, the hole can be a round hole or an angular hole.

In a coarse aggregate 1D for concrete shown in FIG. 6d, an iron ball as a core material 6 is put inside the protruded portion 2 of the coarse aggregate 1C for concrete shown in FIG. 5Ad and FIG. 5Bd in order to increase the specific gravity of the coarse aggregate 1D as a whole, thereby preventing floating of the coarse aggregate 1D in fresh concrete.

In a coarse aggregate 1E for concrete shown in FIG. 7d, two protruded portions 2 having a substantially spherical shape are disposed side by side in the coarse aggregate 1C for concrete shown in FIG. 5Ad and FIG. 5Bd. Disposing the protruded portions 2 side by side in this manner can further prevent the occurrence of displacement, in the concrete, of the coarse aggregate in which the metallic mesh material and the mortar are integrated with each other, and thus tensile strength of the concrete can be further improved. Further, such coarse aggregates including a plurality of the protruded portions 2 can be assembled with each other. The coarse aggregates assembled with each other in the concrete further increase the tensile strength of the concrete.

In a coarse aggregate 1F for concrete shown in FIG. 8d, three protruded portions 2 having a substantially spherical shape are disposed side by side in the coarse aggregate 1E for concrete shown in FIG. 7d.

A coarse aggregate 1G for concrete shown in FIG. 9d is formed in a substantially tetrahedral shape by molding a metallic mesh material M of a woven net into a cylindrical body and sequentially crushing the cylindrical body at a predetermined interval in alternate directions in a transverse direction of the cylindrical body, followed by cutting, while the core material 6 is put inside the cylindrical body. This coarse aggregate 1G has exceptionally excellent mass productivity and can be produced at a low cost.

A coarse aggregate 1H for concrete shown in FIG. 10d is formed in a shape in which two substantial tetrahedrons are connected to each other by sharing one side. This coarse aggregate 1H is obtained by molding a metallic mesh material M of a woven net into a cylindrical body and sequentially crushing the cylindrical body at a predetermined interval in alternate directions in a transverse direction of the cylindrical body while the core material 6 is put inside the cylindrical body. This coarse aggregate 1H makes it possible to improve tensile strength, shearing strength, and adhesion strength of the concrete more than the coarse aggregate 1G shown in FIG. 9d.

A coarse aggregate 1I for concrete shown in FIG. 11d is produced by molding a metallic mesh material M of a woven net into a substantially cubic shape as an outer shape.

A coarse aggregate 1J for concrete shown in FIG. 12d is produced by wrapping two core materials 6 with a metallic mesh material M of a woven net to form a barrel shape.

A coarse aggregate 1K for concrete shown in FIG. 13d is produced by wrapping a core material 6 with a perforated metal M having an angular hole and molding this in a substantially streamline shape by squeezing the upper end portion with a wire 7.

A coarse aggregate 1L for concrete shown in FIG. 14d is produced by bonding ring-shaped annular materials 8 to one another around a spherical core material 6 such that the entire surface of the core material 6 is covered with the ring-shaped annular materials 8.

A coarse aggregate 1M for concrete shown in FIG. 15d is produced by bonding bent annular materials 8 to one another around a spherical core material 6 such that the entire surface of the core material 6 is covered with the bent annular materials 8.

A coarse aggregate 1N for concrete shown in FIG. 16d is produced by bringing four metallic balls into contact with one another and bonding them to one another to obtain a core material 6, covering the core material 6 with the metallic mesh material having a tetrahedral shape, inserting a rigid wire 9 so as to penetrate a gap at the center of the core material 6, and bending the wire 9 at its both ends. In this configuration, the rigid wire 9 penetrating the coarse aggregate body is bent at its ends. Thus, the coarse aggregates 1N are connected to each other by the wires 9 entangled with each other in the fresh concrete, as a result, tensile strength and the like of the concrete are further improved. Further, the wire 9 can be easily passed through the gap of the core material 6 which is obtained by bonding the metallic balls to one another.

As described above, the coarse aggregate for concrete of the fourth mode of the present invention is characterized in that the entire outer surface is formed by the metallic mesh material, and thus it can take various outer shapes.

### (Application Example of Coarse Aggregate)

The coarse aggregate for concrete of the fourth mode of the present invention can partially or wholly replace the coarse aggregate in the blending composition of the conventional concrete. As a preferable application example of the coarse aggregate for concrete of the fourth mode of the present invention, as a concrete precast product, for example, the hollow coarse aggregate of the present invention can be used to produce a light-weight ferroconcrete plate that is more resistant to tension and bending than the conventional one. Further, it can be preferably applied to a concrete structure not including a reinforcing bar (e.g., a dam wall, a road directly laid on the ground surface, a mat foundation for a construction, and a paved square). As a specialized application example, it can be preferably applied to a ferroconcrete floor slab for a highway constructed at a position away from the ground surface, or the like. The coarse aggregate for concrete of the fourth mode of the present invention in which the core material is made of iron and the ratio occupied by the core material is increased can be useful as a coarse aggregate for heavyweight concrete used for shielding radiation in a nuclear facility or the like. Further, when the metallic mesh material or the core material is constituted from a magnetic material, conveyance, installation, and removal of a concrete panel can be performed through attraction to an electromagnet, and thus workability is improved.

### REFERENCE SIGNS LIST

### (First Mode of the Present Invention)

1A, 1B, 1C, 1D, 1E coarse aggregate
2 spherical cap portion
2g bottom surface of spherical cap portion
3 spherical cap portion bonded body
3a recessed portion
4 flange
5 annular portion
5p, 5q bent piece
5x cut
6 metal plate
11 small piece of metal pipe
12 die
d depth of recessed portion
H height of spherical cap portion
L protrusion length (maximum length) of annular portion
R radius of sphere of spherical cap portion
t thickness of spherical cap portion
O1 center of sphere
O2 center of bottom surface

### (Second Mode of the Present Invention)

1A, 1A′, 1B, 1C, 1D, 1E, 1F, 1G, 1H, 1I, 1J, 1K, 1L, 1M, 1N coarse aggregate
2 spherical cap portion
2g bottom surface of spherical cap portion
3, 3a, 3b, 3c spherical cap portion bonded body,
3 spherical portion
4 flange
5 annular portion
8 small piece of metal bar
9 die
11 small piece of metal pipe
12 die
13a wire
D diameter of spherical portion
H height of spherical cap portion
L protrusion length of annular portion
La extension line of chord of spherical portion
R radius of sphere of spherical cap portion
t thickness of spherical cap portion
P connection portion
W width of coarse aggregate at connection portion

### (Third Mode of the Present Invention)

1A, 1B, 1C, 1D, 1E, 1F, 1G, 1H, 1I, 1J, 1K, 1L, 1M, 1N, 1O, 1P coarse aggregate
1A′, 11′, 1J′, 1L′, 1M′, 1Q′, 1R′, 1S′, 1T′, 1U′, 1V′ coarse aggregate body
2, 2a, 2b spherical cap portion
2g bottom surface of spherical cap portion
2h bottom surface of spherical cap
3 spherical cap portion bonded body
3a recessed portion
4, 4a, 4b flange
5 annular portion
5x cut
6 metal plate
7 metal bar
8 small piece
9 die
10 cylindrical portion
11 small piece of metal pipe
12 die
13a wire
14 metallic mesh material
15 outer fitting portion
d depth of recessed portion
h height of spherical cap portion
L protrusion length of annular portion
L2 length of protrusion portion of wire
L3 maximum diameter of spherical cap portion bonded body
r radius of sphere of spherical cap portion
t thickness of spherical cap portion
O1 center of sphere
O2 center of bottom surface

### [Fourth Mode of the Present Invention]

1A, 1B, 1C, 1D, 1E, 1F, 1G, 1H, 1I, 1J, 1K, 1L, 1M, 1N coarse aggregate for concrete
2 protruded portion
3 flange
4 hemispherical protruded portion
5 flange
6 core material
7 wire
8 annular material
9 wire
M metallic mesh material, perforated metal

1. A metallic coarse aggregate for concrete comprising a coarse aggregate body including a spherical cap portion bonded body having two hollow spherical cap portions and an annular portion protruding from a surface of the spherical cap portion bonded body so as to surround an outer periphery of the spherical cap portion bonded body, the annular portion having a shape in which a corner of a rectangular shape is bent upward or downward.

2. The coarse aggregate for concrete according to claim 1, wherein adjacent corners of the annular portion are alternately bent upward or downward.

3. The coarse aggregate for concrete according to claim 1, wherein corners of the annular portion each have a bent piece alternately bent upward or downward.

4. A method for producing the coarse aggregate for concrete according to claim 1, comprising:
performing press processing using a rectangular metal plate to form a spherical cap portion with flange having a rectangular flange at a bottom portion thereof;
disposing the bottom portions of two spherical cap portions with flange so as to face each other; and
pressure-bonding the flanges of the two spherical cap portions with flange to each other by press processing and bending a corner of a rectangular annular portion upward or downward.

5. A metallic coarse aggregate for concrete comprising a plurality of spherical portions, and an annular portion protruding from a surface of the spherical portions so as to surround an outer periphery of the plurality of spherical portions, wherein the plurality of spherical portions are directly connected to each other, and a width of the coarse aggregate in a connection portion of the spherical portions on a surface formed by an outer edge of the annular portion is equal to or greater than a minimum diameter among diameters of the plurality of spherical portions.

6. The coarse aggregate for concrete according to claim 5, wherein the spherical portions are hollow.

7. The coarse aggregate for concrete according to claim 5, wherein the spherical portions are solid.

8. The coarse aggregate for concrete according to claim 5, having a surface to which metal particles formed from molten metal droplets are welded.

9. The coarse aggregate for concrete according to claim 5, comprising a flexible wire penetrating the spherical portion and protruding from the annular portion.

10. The coarse aggregate for concrete according to claim 5, comprising a flexible wire penetrating the spherical portion and protruding from the spherical portion.

11. A method for producing the metallic coarse aggregate for concrete according to claim 5, comprising:
performing press processing using a metal plate to form spherical cap portions with flange in which bottom portions of the spherical cap portions are continued by the flange; and
welding the flanges of two spherical cap portions with flange to each other.

12. A method for producing the metallic coarse aggregate for concrete according to claim 9, comprising: performing press processing using a metal bar or a metal pipe to mold the spherical portion and the annular portion.

13. A method for producing the metallic coarse aggregate for concrete according to claim 9, comprising:
performing press processing using a metal plate to form spherical cap portions with flange in which bottom portions of the spherical cap portions are continued by the flange;
disposing the bottom portions of two spherical cap portions with flange so as to face each other via the flexible wire; and
welding the opposing flanges to each other.

14. A method for producing the metallic coarse aggregate for concrete according to claim 9, comprising:
passing the flexible wire through inside a metal pipe; and
performing press processing using the metal pipe through which the wire is passed to form the spherical portion and the annular portion such that the wire protrudes from the annular portion.

15. A method for producing the metallic coarse aggregate for concrete according to claim 10, comprising:
performing press processing a metal bar or a metal pipe to form the spherical portion and the annular portion;
making a through-hole in the spherical portion; and
passing the flexible wire through the through-hole.

16. A metallic coarse aggregate for concrete, comprising:
a coarse aggregate body including a spherical cap portion bonded body having two hollow spherical cap portions and an annular portion protruding from a surface of the spherical cap portion bonded body so as to surround an outer periphery of the spherical cap portion bonded body; and
a plurality of flexible wires penetrating the spherical cap portion bonded body and protruding from the spherical cap portion bonded body or the annular portion, wherein
a length of a protrusion portion of the wire (when a part of the wire protruding outside the coarse aggregate body is bent, whether one end of the protrusion portion is held by the coarse aggregate body or both ends of the protrusion portion are held by the coarse aggregate body with the protrusion portion forming a loop, a length of the part of the wire protruding outside the coarse aggregate body when it is extended to a straight line in a state in which the end held by the coarse aggregate body remains held) is 1 to 5 times a maximum diameter of the spherical cap portion bonded body.

17. The coarse aggregate for concrete according to claim 16, wherein the wire protrudes from the annular portion.

18. The coarse aggregate for concrete according to claim 16, wherein a plurality of the coarse aggregate bodies are provided, and the wires penetrate the respective spherical cap portion bonded bodies.

19. A method for producing the coarse aggregate for concrete according to claim 17, comprising performing press processing using a metal pipe through which the plurality of flexible wires are passed, to form the spherical cap portion bonded body and the annular portion and to cause the plurality of flexible wires to protrude from the annular portion.

20. A method for producing the coarse aggregate for concrete according to claim 17, comprising:
performing press processing using a metal plate to form the spherical cap portion with flange having a flange at a bottom portion thereof;
disposing the bottom portions of two spherical cap portions with flange so as to face each other as well as disposing the plurality of flexible wires between the spherical cap portions with flange so as to cross them; and
pressure-bonding the flanges of the two spherical cap portions with flange to each other by press processing as well as holding the plurality of wires between the flanges.

21. A method for producing a coarse aggregate for concrete including a spherical cap portion bonded body having two hollow spherical cap portions and an annular portion protruding from a surface of the spherical cap portion bonded body so as to surround an entire outer periphery of the spherical cap portion bonded body, the method comprising performing press processing using a metal pipe to form the spherical cap portion bonded body and the annular portion surrounding the entire outer periphery of the spherical cap portion bonded body.

22. A metallic coarse aggregate for concrete comprising:
a coarse aggregate body for concrete including a spherical cap portion bonded body having two hollow spherical cap portions and an annular portion protruding from a surface of the spherical cap portion bonded body so as to surround an outer periphery of the spherical cap portion bonded body; and
a wire which is not adhered to the coarse aggregate body and is wound around an outer surface of the coarse aggregate body.

23. The coarse aggregate for concrete according to claim 22, wherein the annular portion is rectangular in plan view.

24. A metallic coarse aggregate for concrete comprising:
a coarse aggregate body for concrete including a spherical cap portion bonded body having two hollow spherical cap portions and an annular portion protruding from a surface of the spherical cap portion bonded body so as to surround an outer periphery of the spherical cap portion bonded body; and
an outer fitting portion obtained by molding a bent wire into an annular shape so as to externally fit to the coarse aggregate body.

25. A coarse aggregate for concrete, formed by molding a metallic woven net into a hollow shape.

26. The coarse aggregate for concrete according to claim 25, comprising a protruded portion having a hollow interior, and a flange formed around an entire periphery of the protruded portion.

27. A coarse aggregate for concrete formed by molding a metallic mesh material into a hollow shape, the coarse aggregate having a core material therein.

28. The coarse aggregate for concrete according to claim 27, wherein the core material is iron.

29. The coarse aggregate for concrete according to claim 27, wherein the core material is foamed glass.
